(19) United States
(12) Patent Application Publication
(10) Pub. No.: US 2002/0131142 A1
(43) Pub. Date: Sep. 19, 2002

(54) System and method for tailoring dispersion within an optical communication system

(76) Inventors: Chi-Hao Cheng, Dallas, TX (US); Charles Wong, Richardson, TX (US); Tiejun Xia, Richardson, TX (US); Kuang-Yi Wu, Plano, TX (US); Leo Lin, Richardson, TX (US)

Correspondence Address: BAKER BOTTS L.L.P., 2001 ROSS AVENUE, SUITE 600, DALLAS, TX, 75201-2980, US

(21) Appl. No.: 09/773,447

(22) Filed: Jan. 31, 2001

(51) Int. Cl. G02F 1/03; G02F 1/07

(52) U.S. Cl. 359/246

(57) ABSTRACT

component. 43. (New) The method of claim 39, wherein: the optical signal exiting the optical component comprises a first polarization and a second polarization; and

the rotation angle is further determined based upon at least one of the first polarization of the optical signal exiting the optical component and the second polarization of the optical signal exiting the optical component. 44. (New) The method of claim 39, wherein the property of the dispersion characteristic associated with the optical signal exiting the optical component is selected to compensate for a dispersion characteristic imparted upon the optical signal by at least one dispersion introducing component. A method and system enables the tailoring or managing of the dispersion, particularly chromatic dispersion, introduced onto a signal, such as a WDM signal, by an optical component, device, apparatus, system, network, etc. In one embodiment, the present invention allows for tailoring dispersion through arranging the rotation angle of a first crystal element of an optical component, the polarization of the signals being inputted into the optical component, and/or the polarization transitions occurring within the component in a manner enabling a desired dispersion characteristic. By arranging or tailoring the dispersion characteristic(s) for the optical components, the dispersion characteristics of a device, network, system, etc. including such components may be managed or tailored as well. In at least some embodiments, the configuration of the optical component(s) to tailor dispersion is done in accordance with dispersion properties shown in a dispersion matrix.

### TECHNICAL FIELD

This invention relates generally to optical communication systems, and more particularly to a system and method for tailoring dispersion within an optical communication system.

### BACKGROUND

Traditionally, systems that include optical devices, exclusively or partially, for communicating information (typically digitally), switching, routing, transmitting and the like, suffer from some form of dispersion. Dispersion can occur either during transmission along optical fiber cables (or other transmission lines) or as a result of discrete devices or components such as optical routers, switches, hubs, bridges, multiplexers, and the like.

In general, dispersion can lead to a broadening, smearing, or other forms of distortion of signal waveforms, ultimately causing problems such as detection and/or demodulation errors and the like. To illustrate, an optical signal comprising a sequential plurality of (ideally) square-edged pulse waveforms is propagated along an optical transmission line. In most circumstances, the fact that different wavelengths have different effective rates of transmission along the optical transmission line and/or different indices of refraction and reflection can lead to pulse (or other signal) degradation, such that the original signal comprising a sequential plurality of square-edged pulses may, as a result of dispersion, be changed such that each pulse, rather than retaining a substantially square-edged shape, will have a more rounded, Gaussian shape. Such dispersion can lead to undesirable consequences, e.g., partial overlap between successive pulses which may result in problems such as high bit error rates, decreased detection rates, decreased a signal-to-noise ratio, decreased spectral efficiency, optical energy interference, etc., especially when combined with signal loss (amplitude reduction).

Dispersion has many forms including polarization mode dispersion (“PMD”) and chromatic dispersion within a passband. PMD is a type of dispersion that occurs when the polarization components of a light beam each experience a different index of refraction. Thus, one component travels faster than the other components. Similarly, chromatic dispersion within a passband results from differing wavelengths of light propagating at different speeds through an optical medium (i.e., chromatic dispersion is the wavelength dependent variation in the propagation of a wave in a medium). Thus, similar to PMD, some spectral content of the light will travel faster than other portions of the light. Chromatic dispersion may be expressed in units of picoseconds per nanometer (ps/nm).

This dispersion of optical signals resulting from optic fibers and/or discrete optical components, devices, etc., is an even more severe problem when wavelength division multiplexing (WDM) is involved. Wavelength division multiplexing has gradually become the standard backbone network for fiber optic communication systems. WDM systems employ signals consisting of a number of different wavelength optical signals, known as carrier signals or channels, to transmit information over optical fibers. Each carrier signal is modulated by one or more information signals. As a result, a significant number of information signals may be transmitted over a single optical fiber using WDM technology. WDM systems have progressed to include dense wavelength-division multiplexing systems (DWDM). Optical components often found in DWDM systems, as well as other types of WDM systems, include those which perform wavelength combining (multiplexing) and separating (demultiplexing) functions. The spectral response of these multiplexers and demultiplexers for DWDM applications are generally accompanied by certain dispersion effects that are determined by the underlying filtering technology.

The dispersion effects of wavelength multiplexing and filtering are very different from those of optical fibers. Optical fiber generally shows a linear dependency of its dispersion characteristic versus wavelength. Wavelength filter, multiplexers and demultiplexers, on the other hand, generally show nonlinear dispersion properties, e.g., correlated to its amplitude (spectral response) within its passband window. Although the accumulated dispersion due to fiber span can be compensated by different methods, such as dispersion compensating fibers or dispersion compensating fiber chirped gratings, dispersions caused by multiplexers/demultiplexers are difficult to compensate by conventional approaches.

### SUMMARY OF THE INVENTION

The present invention is directed toward a system and method that enable tailoring of dispersion characteristics normally imparted to signals in optical communications systems, wherein such tailoring may be performed at the component level all the way up to the system level. In one embodiment, such tailoring involves the tailoring of the sign of the slope of the dispersion characteristic(s) introduced onto an optical signal by virtue of an optical component, device, network, system, etc. In at least one embodiment, such tailoring involves imparting one or more positively sloped dispersion characteristics and/or one more negatively sloped dispersion characteristics to optical signals exiting an optical component, device, network, system, etc.

The present invention includes the recognition that a rotation angle of a first crystal element of an optical component and the polarization(s) of signals entering the component, as well as the polarization transitions, or lack thereof, occurring within the component may affect at least one property of the dispersion characteristic(s) imparted to signals propagating through the component.

In one aspect, the present invention is directed toward a method for tailoring dispersion of an optical signal. In at least one embodiment, this method includes receiving an optical signal at a crystal element of an optical component, the crystal element being arranged at a rotation angle based at least in part upon a polarization of the optical signal entering the crystal element and a selected property of at least one dispersion characteristic to impart upon the optical signal exiting the optical component. The method further includes communicating the optical signal exiting the optical component.

In at least one of these embodiments, the crystal element includes a first crystal element, the optical component includes a first optical component, and the optical signal exiting the first optical component comprises an intermediate optical signal. Moreover, in such embodiments, the method further includes receiving the intermediate optical signal at a crystal element of a second optical component, the crystal element of the second optical component arranged at a rotation angle based upon a polarization of the intermediate optical signal entering the crystal element of the second optical component and a selected property of at least one dispersion characteristic to impart upon the intermediate optical signal entering the crystal element of the second optical component and a selected property of at least one dispersion characteristic to impart upon the intermediate optical signal exiting the second optical component. The property of the dispersion characteristic imparted upon the intermediate optical signal exiting the second optical component may be selected to compensate for the dispersion characteristic imparted by the first optical component. Similarly, the dispersion property imparted upon the signal exiting the first optical component may be selected to compensate for the dispersion characteristic imparted by the second optical component.

In yet another embodiment of the above method, receiving and communicating includes propagating the optical signal in a forward propagation path, as well as further including propagating the optical signal through the optical component in a reverse propagation path. In at least one embodiment, propagating the optical signal in the reverse propagation path imparts a dispersion characteristic that compensates for the dispersion characteristic imparted upon the optical signal in the forward propagation path.

In an alternative embodiment, a method for manufacturing an optical component that tailors a dispersion characteristic of an optical signal includes identifying a polarization for the optical signal entering the optical component, wherein the optical component includes at least one crystal element. In this embodiment, the method also includes selecting a property of at least one dispersion characteristic associated with the optical signal exiting the optical component. Morever, the method includes configuring the rotation angle of the crystal element based at least in part upon the polarization of the optical signal entering the crystal element and the selecting property of the at least one dispersion characteristic.

The present invention is also directed toward an optical component for tailoring a dispersion characteristic of an optical signal. In one embodiment, this optical component includes a crystal element arranged at a rotation angle based at least in part upon a polarization of the optical signal entering the crystal element and a selected property of at least one dispersion characteristic to impart upon the optical signal exiting the optical component.

In another embodiment of the present invention, an optical device for tailoring a dispersion characteristic of an optical signal includes a first beam displacer operable to decompose an input optical signal into a first intermediate optical signal having a first polarization and a second intermediate optical signal having a second polarization. The device also includes a polarization rotator coupled to the first beam displacer and operable to process the second intermediate optical signal such that it has the first polarization. The optical device further includes a waveplate filter comprising a plurality of waveplates operable to receive the intermediate optical signals, wherein at least one of the waveplates comprises a crystal element arranged at a rotation angle based at least in part upon the polarization of the intermediate optical signals entering the crystal element, and a selected property of at least one dispersion characteristic associated with the intermediate optical signals exiting the waveplate filter. Moreover, the optical device includes a second beam displacer operable to combine a portion of the intermediate optical signals exiting the waveplate filter to generate an output signal.

In still yet another embodiment of the present invention, a system for tailoring a dispersion characteristic of an optical signal is disclosed. The system includes a dispersion tailoring device operable to process an input optical signal into at least one output optical signal, the dispersion tailoring device comprising at least one filter having at least one crystal element arranged at a rotation angle based at least in part upon a polarization of an intermediate optical signal entering the crystal element and a selected property of at least one dispersion characteristic associated with the intermediate optical signal exiting the filter, wherein the output optical signal is generated using the intermediate optical signal exiting the filter. The system further includes at least one dispersion introducing component that imparts a dispersion characteristic to one of the input optical signal and the output optical signal. In the system, the property of the dispersion characteristic associated with the intermediate optical signal exiting the filter is selected to compensate for the dispersion characteristic imparted by the at least one dispersion introducing component.

It should be recognized that one technical advantage of one aspect of at least one embodiment of the present invention is the ability to achieve a desired dispersion characteristic or characteristics by tailoring the dispersion characteristic(s) of at least one optical component through implementing at least one of a rotation angle of a first crystal element of the optical component, the polarization(s) of signals entering the component, and the polarization transitions, or lack thereof, occurring within the component so as to enable a dispersion characteristic for the component that provides for the achievement of the desired dispersion characteristic.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWING

For a more complete understanding of the present invention, reference is made to the following descriptions taken in conjunction with the accompanying drawing, in which:

FIG. 1 shows an exemplary rotation angle of an exemplary crystal structure;

FIG. 2 shows a first exemplary embodiment of a dispersion matrix;

FIG. 3 shows a second exemplary embodiment of a dispersion matrix;

FIG. 4 shows an exemplary embodiment of a waveplate filter;

FIG. 5a shows an exemplary dispersion characteristic for an optical signal propagating along an exemplary optical path;

FIG. 5b shows a second exemplary dispersion characteristic for an optical signal propagating along an exemplary optical path;

FIG. 6 shows an exemplary flow diagram for arranging an optical device to achieve a desired dispersion characteristic in accordance with an embodiment of the present invention;

FIG. 7 shows an exemplary embodiment of a device that may be arranged in accordance with an embodiment of the present invention to achieve a desired dispersion characteristic in accordance with the present invention;

FIG. 8 shows an embodiment of the device of FIG. 7 arranged under an embodiment of the present invention such that substantially zero dispersion is introduced onto signals exiting the device;

FIG. 9 shows a partial block diagram illustrating the phenomenon that some undesirable optical signals will not interfere with the desired optical signals at the output of an optical system as illustrated in FIG. 8;

FIG. 10 shows a partial block diagram illustrating the phenomenon that some undesirable optical signals will not interfere with the desired optical signals at the output of an optical system as illustrated in FIG. 8;

FIG. 11 shows an exemplary embodiment of an optical communications system;

FIG. 12 shows an exemplary embodiment of a device that has been arranged in accordance with an embodiment of the present invention such that particular negatively signed dispersion is achieved at one output of the device;

FIG. 13 shows a simplified block diagram illustrating an optical assembly according to an embodiment of the present invention comprising cascading optical devices; and

FIG. 14 shows an exemplary embodiment of a single component device of the present invention that may be arranged in accordance with an embodiment of the present invention to achieve a desired dispersion characteristic.

### DETAILED DESCRIPTION

Various embodiments of the present invention provide the capability of tailoring the dispersion normally imparted to signals by virtue of an optical component, device, system, network, etc.

It was previously recognized in U.S. patent application Ser. No. 09/469,336 (“the '336 application”) entitled “DISPERSION COMPENSATION FOR OPTICAL SYSTEMS,” the disclosure of which is hereby incorporated herein by reference, that the chromatic dispersion occurring in a propagation path where polarization is intact or unchanged may be substantially opposite to the dispersion along a similar propagation path but in which polarization is changed. Expanding upon its recognition that different polarization transitions in similar propagation paths may result in oppositely-signed dispersions, the '336 application teaches, among other things, multi-stage or multi-component optical devices, configured such that dispersion characteristics introduced at two different optical elements along an optical path or contiguous optical paths within one of these optical devices substantially cancel one another out, such as by introducing roughly equal amounts of positive and negative dispersion.

One embodiment of the present invention involves the recognition that the polarization of a signal as it enters an optical component having at least one crystal element, the rotation angle of the first of such at least one crystal element through which the signal passes as it propagates through the optical component, and/or the polarization transition(s), or lack thereof, experienced by the signal as a result of the optical component may affect at least one property of the dispersion characteristic introduced onto the signal by virtue of propagating through the optical component having at least one crystal element.

An embodiment of the rotation angle of a crystal element mentioned above is illustrated in FIG. 1. As can be seen, in the example of FIG. 1, the angle of the crystal element (angle θ), is the angle between the optical axes 10 of the crystal element 12 and a set of fixed laboratory axes 14. For convenience, laboratory axes 14 are labeled x and y. The rotation angle may be positive or negative. Furthermore, the rotation angle may be zero degrees (0°).

Also, in at least one embodiment of the present invention, the polarization of a signal being inputted into an optical component is either extraordinary or ordinary, as would be understood by one of ordinary skill in the art. Extraordinary polarizations may be either horizontal or vertical. The same holds true for ordinary polarizations, which are orthogonal to extraordinary polarizations. Horizontal polarization refers to light polarization that is parallel to the fixed laboratory axes mentioned earlier, while vertical polarization refers to light polarization that is perpendicular to the fixed laboratory axes.

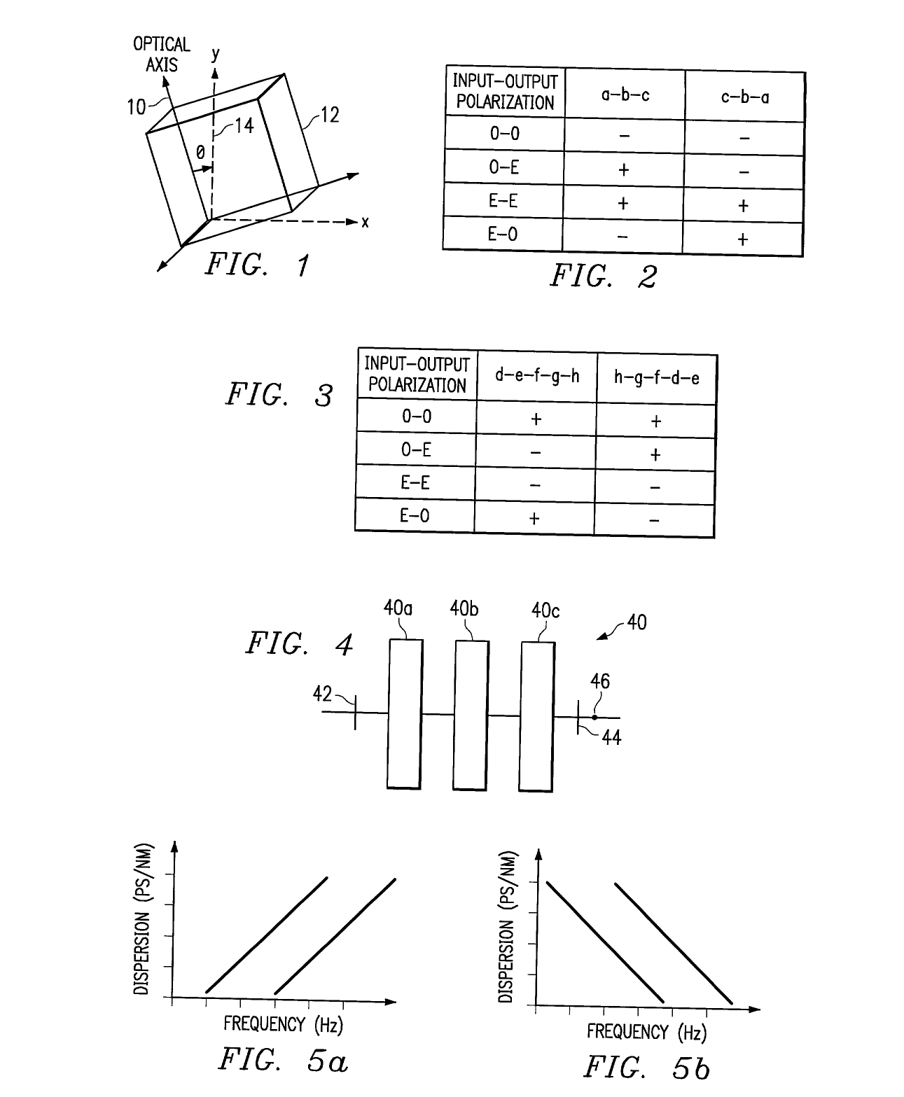

FIG. 2 illustrates the effect the rotation angle of a first crystal element of an optical component, the input polarization(s) of the signal(s) entering the optical component, and/or the polarization transitions, or lack thereof, occurring within the component, may have on the dispersion characteristic(s) that may be introduced by the optical component onto an optical signal(s) propagating therethrough. In particular, FIG. 2 shows a dispersion matrix, a dispersion matrix being a table that lists properties of dispersion characteristics associated with an optical component(s), e.g., all of the possible signs (i.e., signs of the slopes) for the dispersion characteristic(s) that may be introduced onto an optical signal(s) by virtue of the signal(s) propagating through an optical component having at least one crystal element. The particular matrix of FIG. 2 describes the slope of the dispersion characteristics with respect to a specific spectrum, rather than the entire spectrum. Particularly, in the case of the matrix of FIG. 2, the dispersion characteristics that are described are the dispersion characteristics of passband. The chromatic dispersion characteristics of stop band are not considered since there is very little energy in the stop band spectrum.

In the particular dispersion matrix of FIG. 2, the first column lists possible input-output polarizations for signals passing through an optical component having three crystal elements, e.g., waveplate filter 1100 of the '336 application. In this first column of FIG. 2, an “E” represents an extraordinary polarization, while an “O” represents an ordinary polarization. Therefore, the input-output polarization listings E-E and O-O in the first column symbolize that no polarization transition occurs, whereas listings E-0 and O-E symbolize that a polarization transition does occur.

The second column of the particular matrix of FIG. 2 lists the possible signs for the dispersion characteristic(s) that may be introduced onto a signal by the optical component given the polarization transitions listed in the first column and a specific crystal rotation angle set “a-b-c” for the optical component (“a” referring to the rotation angle of the first crystal element of the component (e.g., 35°), “b” referring to the rotation angle of the second crystal element (e.g., −76°) and “c” referring to the rotation angle of the third crystal element (e.g., −64°)). A “+” in the matrix of FIG. 2 represents a dispersion characteristic having a slope of a particular sign. Likewise, a “−” represents a dispersion characteristic having a slope that is opposite in sign compared to that of a “+” dispersion characteristic. In at least one embodiment, a “+” symbolizes a positively sloped dispersion characteristic, while a “−” symbolizes a negatively sloped dispersion characteristic.

With respect to the slope of a dispersion characteristic(s) and the matrix of FIG. 2, dispersion may be defined as the derivative of group delay with respect to wavelength, the unit of group delay being picoseconds (ps) and the unit of dispersion being picoseconds per nanometer (ps/nm). In some instances, a second-order polynomial of wavelength may be used to describe or curve fit the group delay of a component, device, etc. For example, a function such as G(L)=aL²+bL+c, where L is wavelength may be used for such a purpose. In such an instance, the dispersion of the device can be expressed as 2aL+b. Thus, the dispersion characteristic of a device, component, etc. may appear as highly linear function curves.

Examples of linear dispersion characteristics are provided in FIGS. 5A and 5B. As can be seen, the dispersion characteristics of FIGS. 5A and 5B are defined as dispersion with respect to frequency. Therefore, the slope of these dispersion characteristics may be described as Δ(ps/mn)/Δf. Thus, under such a definition of slope, the slope of the dispersion characteristic of FIG. 5A is positive. Likewise, the slope of the dispersion characteristic of FIG. 5b is negative. Of course, these dispersion characteristics, as well as their slopes, could be defined in other ways. For example, the dispersion characteristics of FIGS. 5A and 5B could be defined instead as dispersion with respect to wavelength. In such an instance, the slope of the dispersion characteristics would be defined as Δ(ps/nm)/ΔL (where L refers to wavelength).

For the particular matrix of FIG. 2, the slope(s) of the dispersion characteristic(s) represented by “+” or “−” is defined in terms of Δ(ps/nm)/Δf. Therefore, where a “+” symbolizes a positively sloped dispersion characteristic, Δ(ps/run)/Δf for the characteristic represented by the “+” is greater than zero. Similarly, where a “−” represents a negatively sloped characteristic, Δ(ps/mn)/Δf for the characteristic represented by the “−” is less than zero.

Of course, a matrix may represent dispersion characteristics defined in a manner other than with respect to frequency. For example, a matrix may relate to dispersion characteristics defined with respect to wavelength. If this was case with respect to the matrix of FIG. 2, each “+” of the matrix would be switched for a “−” and vice versa on account of the fact that wavelength is the inverse of frequency. Regardless of how dispersion characteristics are defined for representation in the matrix of FIG. 2, various embodiments enable arrangements of crystal elements for tailoring such dispersion characteristics in a desired manner.

The third column of the matrix of FIG. 2 lists the possible signs for the dispersion(s) that may be introduced onto a signal by the optical component if the order of the crystal elements was reversed, i.e., “c-b-a” (e.g., −64°, −76°, 35°) As can be seen in FIG. 2, when the rotation angle of the first crystal element of the optical component through which a signal(s) passes is “a”, the dispersion characteristic introduced onto a signal having an input-output polarization of E-O along a propagation path through the optical component has a “−” sign, which is opposite in sign compared to that of the dispersion characteristic introduced when the input-output polarization along the propagation path is E-E (i.e., a “+” sign). Also, the dispersion characteristic introduced onto a signal when the signal's input-output polarization is O-E along the propagation path has a “+” sign, which is opposite in sign when compared to that of the dispersion characteristic introduced when the input-output polarization along the propagation path is O-O (i.e., “−” dispersion).

However, when the order of the crystals is reversed such that the rotation angle of the first crystal element is now “c”, the dispersion characteristic introduced onto a signal having an input-output polarization of E-O along the propagation path has a “+” sign, which is the same sign as that of the dispersion characteristic introduced when the input-output polarization along the propagation is E-E (i.e., a “+” sign). Likewise, the dispersion characteristic introduced onto the signal when the input-output polarization is O-E along the propagation path has a “−” sign, which is the same sign as the dispersion characteristic introduced when the input-output polarization along the propagation path is O-O (i.e., a “−” sign).

Moreover, in the matrix of FIG. 2, no matter whether the rotation angle of the first crystal element is “a” or “c”, the dispersion characteristic introduced when the input-output polarization along the propagation path is O-O is opposite in sign compared to that of the dispersion characteristic introduced when the input-output polarization along the propagation path is E-E (i.e., “−” v.s. “+”).

Once the effect that the rotation angle of the first crystal element, the input polarization(s) of the signal(s) entering the optical component, and/or the polarization transitions, or lack thereof, occurring within the component may have on the dispersion characteristic(s) that may be introduced by the optical component onto an optical signal(s) propagating therethrough is recognized, the properties shown in dispersion matrix of FIG. 2 may be determined, measured, tested, etc., using techniques known in the art. The format of the particular dispersion matrix of FIG. 2 is by way of example only, for numerous other formats may be used to express the properties shown in the matrix of FIG. 2. For example, the polarizations listed in the first column of the matrix need not be expressed in terms of extraordinary and ordinary polarizations but instead may be described in another manner (e.g., horizontal vs. vertical). Similarly, the matrix may include a greater or lesser number of columns and/or rows (e.g., the reverse column (e.g., the “c-b-a” column) may be removed). Likewise, each specific angle need not be included (e.g., in FIG. 2, it would be acceptable if only the angle “a” was listed in the first column heading and only angle “c” was listed in the second column heading). Furthermore, a dispersion property of the rotation angle set “a-b-c” other than the sign of the slope of the dispersion characteristic may be provided. In addition, the columns and rows of the matrix may be switched.

Moreover, in addition to the format, the particular crystal rotation angle set and polarizations of the matrix of FIG. 2 are by way of example as well, for matrices may be generated for crystal rotation angle sets other than “a-b-c” and/or polarizations other than those listed in the matrix of FIG. 2. As an example, FIG. 3 provides a dispersion matrix that shows dispersion properties for a specific crystal angle set “d-e-f-g-h.” Similar to the matrix of FIG. 2, the matrix of FIG. 3 describes the slope of the dispersion characteristics with respect to a specific spectrum, rather than the entire spectrum. Particularly, in the case of the matrix of FIG. 3, the dispersion characteristics that are described are the dispersion characteristics of passband. The chromatic dispersion characteristics of stop band are not considered since there is very little energy in the stop band spectrum.

Also similar to the matrix of FIG. 2, the first column of the matrix of FIG. 3 lists possible input-output polarizations for signals passing through an optical component. However, in this instance, the optical component has at least five crystal elements. Again, an “E” represents an extraordinary polarization, while an “O” represents an ordinary polarization. Therefore, the input-output polarization listings E-E and O-O in the first column symbolize that no polarization transition occurs, whereas listings E-O and O-E symbolize that a polarization transition does occur.

Likewise, the second column of the matrix of FIG. 3 lists the possible signs for the dispersion characteristic(s) that may be introduced onto a signal by the optical component given the polarization transitions listed in the first column and a particular crystal rotation angle set “d-e-f-g-h” for the component (“d” referring to the rotation angle of the first crystal element of the optical component (e.g., −70° ), “e” referring to the rotation angle of the second crystal element (e.g., −24°), “f” referring to the rotation angle of the third crystal element(e.g., 23°), “g” referring to the rotation angle of the fourth crystal element (e.g., −100°), and “h” referring to the rotation angle of the fifth crystal element (e.g., −100°). Again, a “+” represents a dispersion characteristic having a slope of a particular sign (this being a positively sloped characteristic in at least one embodiment). Likewise, a “−” represents a dispersion characteristic having a slope that is opposite in sign compared to that of a “+” dispersion characteristic (this being a negatively sloped characteristic in at least one embodiment). Moreover, similar to the matrix of FIG. 2, the slope(s) of the dispersion characteristic(s) represented by “+” or “−” in the matrix of FIG. 3 are defined in terms of Δ(ps/mn)/Δf. Also similar to the matrix of FIG. 2, regardless of how dispersion characteristics are defined for representation in the matrix of FIG. 3, various embodiments enable arrangements of crystal elements for tailoring such dispersion characteristics in a desired manner.

Similarly, the third column lists the possible signs for the dispersion characteristic(s) that may be introduced onto a signal by the optical component if the order of the crystal elements is reversed, e.g., “h-g-f-e-d” (e.g., −100°, −100°, 23°, −24°,−70°).

As can be seen in the matrix of FIG. 3, when the rotation angle of the first crystal element of the optical component is “d”, the dispersion characteristic introduced onto a signal having an input-output polarization of E-O along a propagation path through the optical component has a “+” sign, which is opposite in sign compared to that of the dispersion characteristic introduced when the input-output polarization along the propagation path is E-E (i.e., “−”). Also, the dispersion characteristic introduced when the input-output polarization is O-E along the propagation path has a “−” sign, which is opposite in sign when compared to that of the dispersion characteristic introduced when the input-output polarization along the propagation path is O-O (i.e., “+”).

However, when the order of the crystals is reversed such that the rotation angle of the first crystal element is now “h”, the dispersion characteristic introduced when the input-output polarization is E-O along the propagation path has a “−” sign, which is the same sign as that of the dispersion characteristic introduced when the input-output polarization along the propagation is E-E (i.e., a “−” sign). Likewise, the dispersion characteristic introduced when the input-output polarization is O-E along the propagation path has a “+” sign, which is the same sign as the dispersion characteristic introduced when the input-output polarization along the propagation path is O-O (i.e., a “+” sign).

Moreover, no matter whether the rotation angle of the first crystal element is “d” or “h”, in the particular matrix of FIG. 3, the dispersion characteristic introduced when the input-output polarization along the propagation path is O-O is “+”, which is opposite in sign compared to that of the dispersion characteristic introduced when the input-output polarization along the propagation path is E-E (i.e., “−”).

Matrices may be generated for any and all combinations of angle values and polarizations. For instance, a matrix can be generated for a crystal rotation angle set having a greater or lesser number of angles than the rotation angle sets of FIGS. 2 and 3 (e.g., a matrix may be generated for a rotation angle set having six angles). Moreover, matrices can be generated for rotation angle sets comprised of angles already present in other matrices (e.g., a matrix may be generated for the angle set “a-b-g-e”).

In at least one embodiment of the present invention, at least one property of a dispersion characteristic(s), e.g., the sign of the slope of a dispersion characteristic(s), that may be introduced onto an optical signal(s) propagating through an optical component having at least a first crystal element may be tailored to approximate or match at least one property of a desired dispersion characteristic(s) using the properties shown in a dispersion matrix, such as the properties shown in the dispersion matrices of FIGS. 2 and 3. In at least one embodiment, such a desired dispersion characteristic may be a positively sloped dispersion characteristic and/or a negatively sloped dispersion characteristic. In one embodiment, the desired tailoring or management of the dispersion may be accomplished by configuring or arranging the optical component such that the polarization of the optical signal(s) entering the optical component, the rotation angle of the first crystal element of the optical component through which the signal(s) passes, and the polarization transition(s) occurring within the component, all provide for the desired dispersion characteristic as taught by the information disclosed in a dispersion matrix. In some instances, only the information provided in a single matrix need be used to configure or arrange the optical component to achieve the desired dispersion characteristic. However, it will be appreciated that dispersion information contained in other dispersion matrices or other sources of such information may be employed as well.

An example of an optical component having at least one crystal element that may be configured, implemented, manufactured, etc. under an embodiment of the present invention to achieve at least one desired property of a desired dispersion characteristic(s) is shown in FIG. 4. FIG. 4 provides an aerial view of a waveplate filter 40. Waveplate filter 40 is made up of a plurality of substantially aligned individual waveplates 40a, 40b, and 40c. In one embodiment, each waveplate is formed of a birefringent crystal, as would be understood by those of skill in the art. While waveplate filter 40 is depicted in FIG. 4 as being comprised of three waveplates (40a, 40b, and 40c), it should be understood that waveplate filter 40 may comprise any number of individual waveplates.

As shown in FIG. 4, upon receipt of input optical signal 42, waveplate filter 40 decomposes input signal 42 into two eigen states (i.e., two components with different polarizations). The first eigenstate carries a first sub-spectrum having the same polarization as that of signal 42 (this polarization being represented by a line in FIG. 4), and the second eigen state carries a complementary sub-spectrum at a polarization orthogonal to that of signal 42 (this orthogonal polarization represented by a dot in FIG. 4). Hence, by virtue of passing through waveplate filter 40, input optical signal 42 is transformed into signal 44 having the same polarization as signal 42 and signal 46 having an orthogonal polarization (signal 44 being a first polarization and signal 46 being a second polarization of an optical signal exiting waveplate filter 40).

Waveplate filters, such as waveplate filter 40, normally introduce some amount of dispersion onto signals propagating therethrough. Suppose for some reason it is desired that the dispersion characteristic(s) introduced onto signals 44 and 46 respectively by virtue of waveplate filter 40 have a “+” slope (e.g., a positively signed slope similar to the dispersion characteristic shown in FIG. 5a). Under at least one embodiment of the present invention, this may be accomplished by configuring/arranging signal 42 and filter 40 according to the properties shown in a dispersion matrix, such as the properties shown in the matrices of FIGS. 2 and 3. For this example, the properties shown in the matrix of FIG. 2 are selected, however, as mentioned, the properties shown in other matrices may be used in place of or in addition to the properties shown in the matrix of FIG. 2.

Under the properties shown in the matrix of FIG. 2, in order to have a “+” signed dispersion characteristic introduced onto both signals 44 and 46 by virtue of waveplate filter 40, the rotation angle of the first crystal element through which input signal 42 passes upon entering filter 40 (i.e., waveplate 40a) should be “c” (e.g., −64°), rather than “a”. Moreover, the polarization of input signal 42 should be extraordinary (E).

To illustrate, according to the properties shown in the matrix of FIG. 2, “+” signed dispersion on both signals 44 and 46 cannot be provided if either “c” or “a” is the rotation angle for waveplate filter 40a and the input polarization of signal 42 is ordinary (0). Therefore, the polarization of signal 42 should be E. If the polarization of signal 42 is not already E prior to entering waveplate filter 40, it can be made so by including an optical component(s) such as a polarization rotator (e.g., a half-wave plate) in the propagation path of signal 42 prior to its entry into waveplate filter 40.

If the polarization of signal 42 is E, since signal 44 exits waveplate filter 40 with the same polarization as input signal 42, the input-output polarizations for signal 44 would then be E-E. Under the properties shown in FIG. 2, whether the rotation angle of waveplate 40a is “a” or “c”, a “+” signed dispersion characteristic would be introduced onto signal 44. However, since signal 46 has a polarization orthogonal to that of signal 42, the input-output polarization for signal 46 would be E-O. According to the properties shown in the matrix of FIG. 2, a “+” signed dispersion characteristic will be provided to a signal having an E-O polarization if the rotation angle of waveplate 40a is set to “c” (e.g., −64°). Therefore, a rotation angle of “c” for the first crystal element and an input polarization of E enables the desired dispersion characteristics to be achieved. In such a configuration, signals 44 and 46 now having the desired dispersion characteristics imparted to them by waveplate filter 40, are communicated to another optical component, device, network, etc.

Although in the above example it is desired that the sign of the slopes of the dispersion characteristics introduced onto signals 44 and 46 be “+”, and therefore, waveplate filter 40 and input signal 42 are configured to achieve these desired dispersion characteristics, other dispersion characteristics may be intentionally introduced onto signals 44 and 46 through configuring waveplate filter 40 and the polarization of input signal 42 according to an embodiment of the method of the present invention. For instance, waveplate filter 40 and the polarization of signal 42 may be configured such that a “+” sloped characteristic is introduced onto signal 44, while a “−” sloped characteristic is imparted to signal 46, or vice versa. On the other hand, waveplate filter 40 and the polarization of signal 42 may be configured such that a “−” sloped characteristic is introduced onto signal 44, as well as signal 46. In at least one embodiment, waveplate 40 and input signal 42 are configured to impart a dispersion characteristic(s) to a signal(s) exiting waveplate filter 40 so as to, at least partially, compensate for a dispersion characteristic imparted to or that will be imparted to a signal by at least one dispersion introducing component (e.g., another waveplate filter, amplifiers, multiplexers, demultiplexers, equalizers, routers, switches, hubs, bridges, waveplates, beam displacers, glass, combinations thereof, and the like), e.g., located before or after waveplate filter 40 within an optical communication system.

Therefore, as can be seen, in one embodiment of the present invention, through using the properties shown in a matrix, such as the properties shown in the matrix of FIG. 2, waveplate filter 40, as well as any other optical component having at least one crystal element, can be arranged so as to achieve any one of a number of different possible dispersion characteristics. Moreover, not only may a dispersion characteristic for a single optical component be tailored or managed through an embodiment of the present invention, but by tailoring or tuning the dispersion characteristic(s) for an optical component(s) that is part of an overall optical device, the dispersion characteristic(s) of the overall optical device may be tailored or managed as well. Further still, the dispersion characteristics of an optical device within an optic network may be tailored or managed to compensate for dispersion introduced by other optical devices within or outside of the optical network.

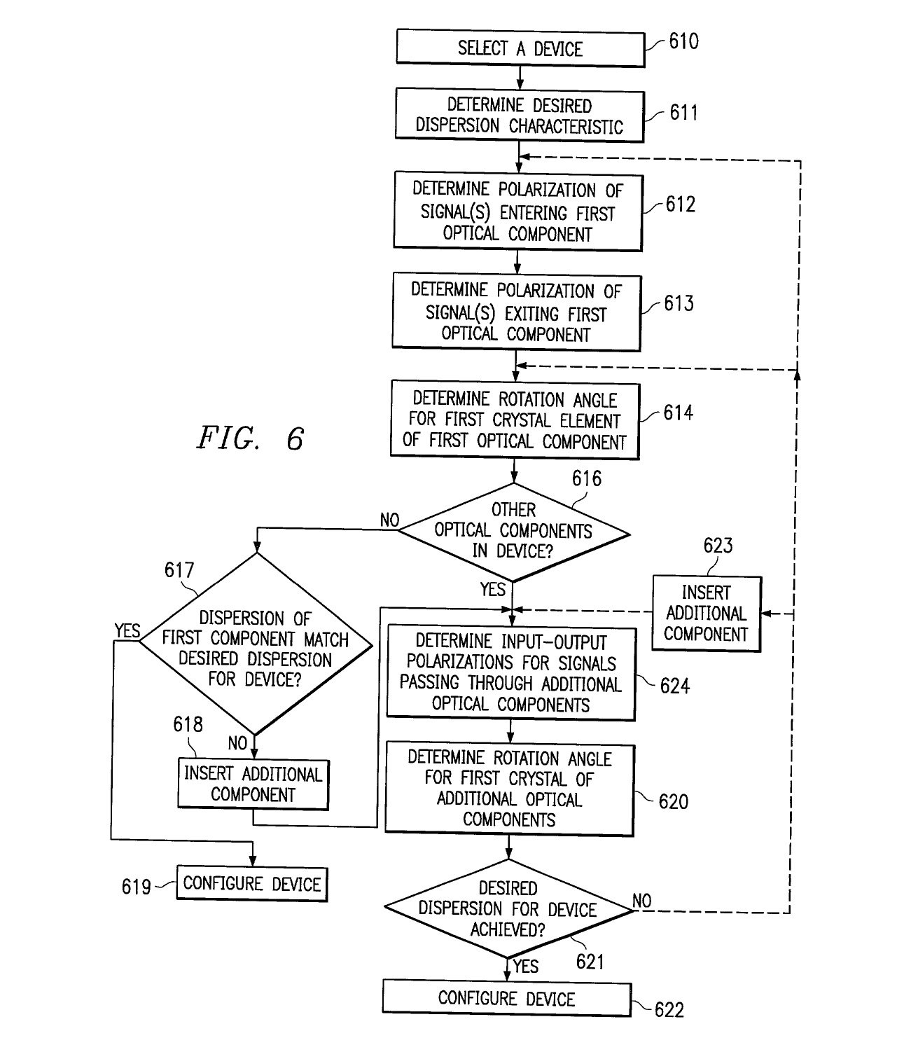

An exemplary flow diagram for an embodiment of a method of the present invention for configuring or arranging an optical component or device to achieve a desired dispersion characteristic(s) is depicted in FIG. 6. Under the flow diagram of FIG. 6, an optical device to be designed, configured, arranged, rearranged, manufactured, etc., to achieve a desired dispersion characteristic(s) is selected (block 610). An actual physical device need not be selected, but instead, only a conception of some portion thereof. In at least one embodiment, once the device is selected, the desired dispersion characteristic(s) to be introduced onto signals by virtue of the device is determined (block 611).

Once a particular device, as well as the desired dispersion characteristic(s) to be provided by the device, is selected, in at least one embodiment of the present invention, the polarization(s) of the signals, preferably either extraordinary or ordinary, entering and exiting a first optical component of the device is then determined (blocks 612 and 613). In one embodiment, the first optical component of a device is the first optical component of the selected device having at least one crystal element through which signals pass upon entering the selected device and that may introduce significant dispersion onto the signals as they pass through the component. In at least one embodiment, determining the polarization of a signal(s) entering the first optical component (block 612) is done by examining/determining the optical devices that precede, or will precede, the selected device in an optical network, and utilizing information gathered from such analysis to determine the polarization of the input beam signals. In an alternative embodiment, an input polarization(s) is selected (e.g., with the aid of properties shown in a dispersion matrix, such as the properties shown in the matrices of FIGS. 2 and 3) and certain optical components (such as a polarization rotator) are incorporated into or combined with the optical device to ensure that the input signal beam(s) possess the selected polarization(s). Furthermore, in at least some embodiments, determining the polarization of a signal(s) exiting the device (block 613) involves tracing or determining the polarization transitions, or lack thereof, occurring within the device to determine the polarization(s) at the output(s) of the device.

In at least one embodiment of the present invention, once the polarization(s) of the signals entering and exiting the first optical component is determined, a rotation angle for the first crystal element of the first optical component of the device is selected or determined (block 614) based, at least in part, on whether the angle will provide at least one property of a desired dispersion characteristic(s) for the first optical component and/or the overall optical device. Moreover, in at least some embodiments, the rotation angle is determined using, at least in part, the input-output polarizations determined at blocks 612 and 613. In at least some of these embodiments, the properties disclosed in a dispersion matrix, such as the properties disclosed in the dispersion matrices of FIGS. 2 and 3, are used as well. Furthermore, in at least one embodiment, the desired dispersion characteristic(s) for the first optical component is a dispersion characteristic(s) that, at least partially, compensates for the dispersion characteristic(s) that are to be imparted by other optical components within or outside of the device.

However, the rotation angle for the first crystal element of the first optical component may have already been selected. In at least some embodiments where the rotation angle has been previously selected, the input-output polarization determined in blocks 612 and 613, as well as the selected rotation angle, are used to determine at least one property of the dispersion characteristic(s) introduced as a result of the first optical component. In at least some of these embodiments, the properties disclosed in a dispersion matrix such as the properties shown in the dispersion matrices of FIGS. 2 and 3 are used as well. In at least one of the embodiments where the rotation angle was previously selected, in addition to the purpose of achieving a desired dispersion property, the rotation angle may have also been selected for purposes unrelated to dispersion.

After the rotation angle enabling the at least one property of the desired dispersion characteristic(s), or the at least one property of the dispersion characteristic(s) resulting from the earlier selected angle, are determined, in at least one embodiment, whether there are or will be any other optical components within the selected device that might introduce dispersion onto the signal(s) after the signal(s) exit the first optical component, e.g., a waveplate filter, (block 616) is ascertained.

If there are no such components in the device, it is determined at block 617 whether the dispersion characteristic(s) introduced by the first optical component approximates or matches the desired dispersion characteristic(s) for the overall device. If so, then if not done already, the optical device may be configured, arranged, rearranged, etc., according to the determined values and polarizations (block 619). If not, an additional optical component may be introduced into or combined with the selected optical device (block 618) and the process advances to block 624 discussed below.

If there are or will be other optical components included in the device that may introduce dispersion onto the signal(s), such as the waveplate filter of FIG. 4, preferably, the input-output polarizations of the signals passing through these other optical components are determined as well (block 624). The output polarizations of these signal(s) depend, at least in part, upon the nature of the optical component(s). For example, if the optical component is a waveplate filter, as discussed earlier, the signals exiting the waveplate filter will have a first polarization (e.g., a polarization equal to that of the signal entering the waveplate filter) and a second orthogonal polarization (e.g., a first extraordinary polarization and a second ordinary polarization).

In at least one embodiment of the present invention, once the input-output polarizations of the signal(s) passing through these other optical components are determined, rotation angles for the first crystal elements of these optical components that will provide for at least one desired property for the desired dispersion characteristic(s) of the additional optical components and/or the device are selected/determined (block 620). In at least some embodiments, the rotation angles are determined, at least in part, using the input-output polarizations determined at block 624. In at least one embodiment, the properties disclosed in a dispersion matrix, such as the properties disclosed in the dispersion matrices of FIGS. 2 and 3, are used as well. Furthermore, in at least one embodiment, the desired dispersion characteristic(s) for the additional optical component(s) is a dispersion characteristic(s) that, at least partially, cancels out or compensates for the dispersion characteristic(s) imparted by the first optical component.

Once the rotation angle(s) has been determined, whether the combination of the dispersion characteristics introduced onto the signal(s) by the different optical components results in the overall optical device introducing the desired dispersion characteristic(s) onto the signal(s) is determined (block 621). If so, if not done already, the optical device may be configured, arranged, rearranged, manufactured, etc. according to the determined values and polarizations (block 622). If not, the process may return to block 612, a new input polarization(s) may be selected, and the process may continue on in the same manner. On the other hand, the process may return to block 614 where a new angle value is determined for the first crystal element of the first optical component, and the process continues on in the same manner. Likewise, an additional optical component may be introduced into or combined with the selected optical device (block 623) and the process returned to block 624.

It shall be appreciated that the steps of the above-described method may be performed in sequences other than that which is illustrated. For example, a desired dispersion characteristic may be determined before any particular device is selected. As another example, the determination of the polarizations of signals passing through additional optical components (block 624) may occur prior to the selection/determination of the rotation angle for the first crystal element of the first optical component (block 614). Likewise, the angle value of the first crystal element of the first optical component (block 614) may be selected/determined prior to determining the input-output polarizations for the first optical component (blocks 612 and 613), as well as before determining the desired dispersion characteristic for the device (block 611).

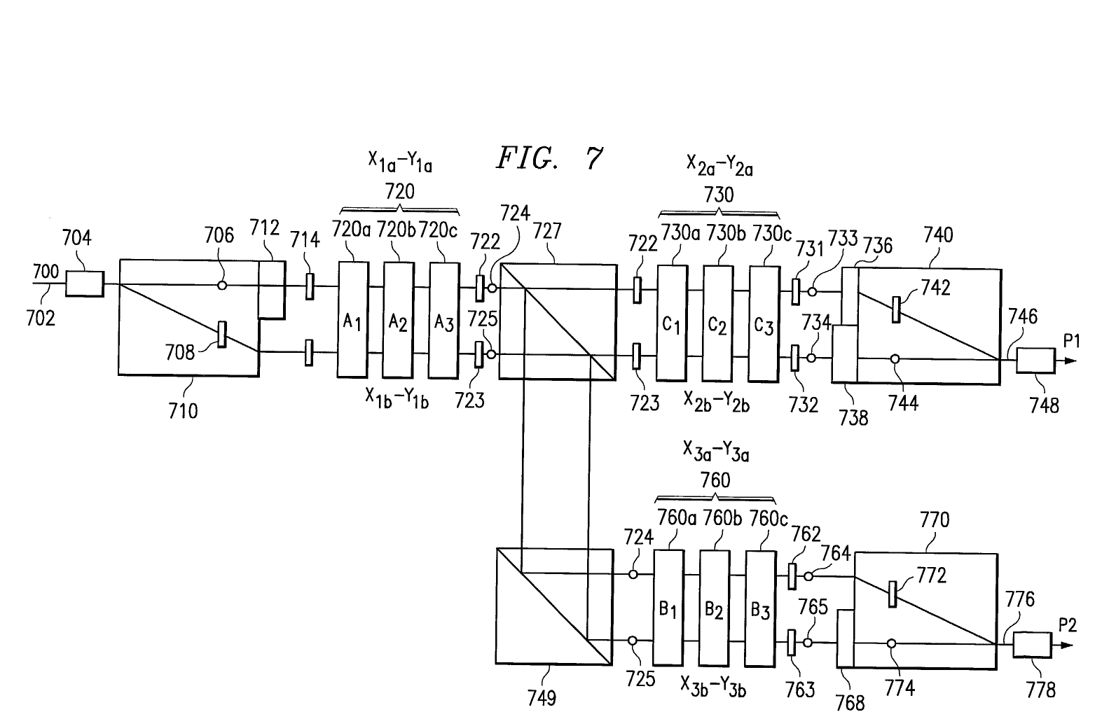

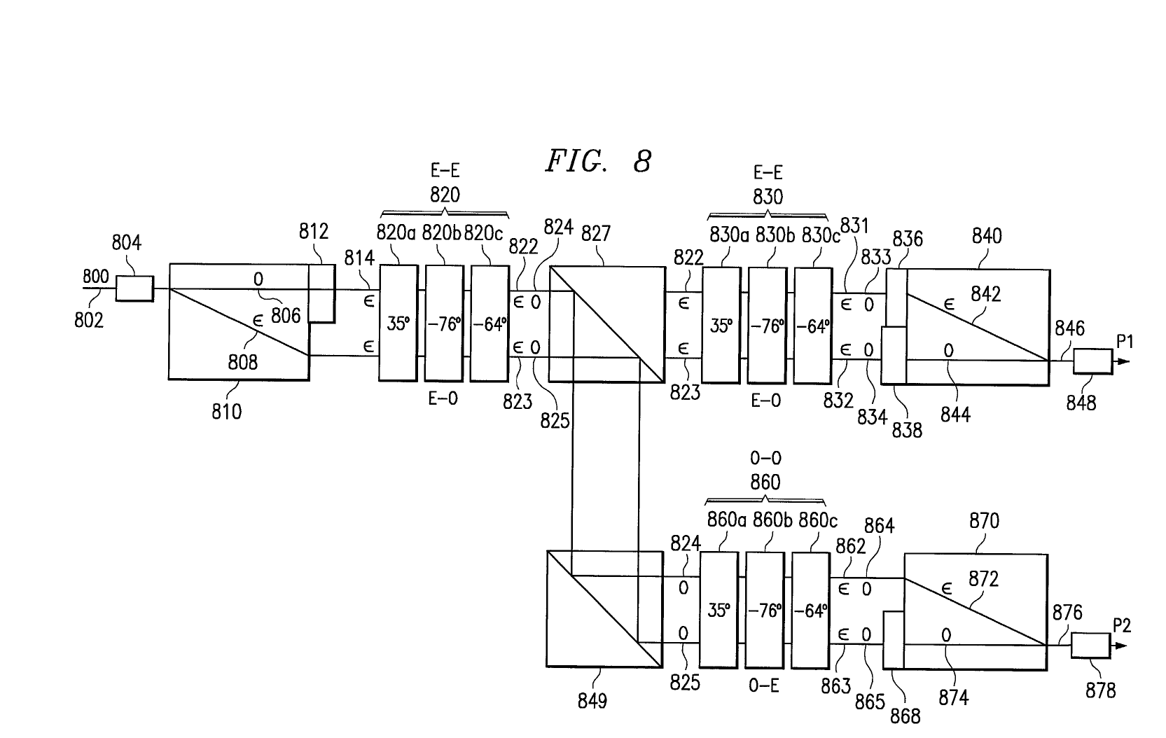

A non-limiting example of a device that may be designed, configured, arranged, rearranged, etc., according to an embodiment of a method of the present invention to provide a desired dispersion characteristic is depicted in FIG. 7. FIG. 7 provides an aerial view of a two-stage, one-input port/two-output ports optical device. Moreover, the exemplary device of FIG. 7 may be used as an interleaver filter. An interleaver filter is an example of a type of demultiplexer sometimes found in WDM systems that normally has the undesirable side effect of introducing dispersion onto a signal. An interleaver filter slices the input spectrum of an input signal beam into two separate interleaved output spectra. Interleaver filters have proven to be extremely important and useful in optical communication system design. However, the chromatic dispersion of interleaver filters seriously hinders their application in some cases. For example, when the free spectral range (“FSR”) of an interleaver becomes smaller, the dispersion introduced by the filter becomes higher (the chromatic dispersion being the second derivative of a phase with respect to frequency and wavelength). As a result, in high-speed transmission systems, 10 Gb/s for example, the dispersion that may be introduced by an interleaver filter is a crucial issue. Examples of interleaver filters can be found in U.S. Pat. No. 5,694,233 (“the '233 patent”) entitled “SWITCHABLE WAVELENGTH ROUTER” (the disclosure of which is hereby incorporated by reference herein).

Other non-limiting examples of components, devices, systems, etc., that may be configured, arranged, rearranged, designed, etc., according to the present invention to provide a desired dispersion characteristic include the devices of the '233 and the '336 applications, as well as amplifiers, filters, multiplexers, demultiplexers, routers, switches, hubs, bridges, waveplates, beam displacers, polarization beam splitters, glasses, combinations thereof, and the like.

In the operation of the device of FIG. 7, an incoming signal 700 passes through an optical fiber 702 and a collimator 704 to enter a beam displacer 710 whereby input signal 700 is decomposed into two components: a signal 706 having a particular polarization represented in FIG. 7 by a dot and a signal 708 having an orthogonal polarization represented in FIG. 7 by a line. The input signal 700 may include a number of different mutiplexed channels (such as a WDM signal) or be a single information stream. After passing through beam displacer 710, signal 706 passes through a half-wave plate 712 whereby its polarization is changed to that of signal 708, the resulting signal being designated as 714. The location of half-wave plate 712 is by way of example only, for in other embodiments, the plate may be placed in the propagation path of signal 708 instead. Although optical signals 708 and 714 have the same polarization, they are spatially separated.

Optical signals 708 and 714 then pass through a stacked waveplate filter 720 made up of a plurality of, preferably substantially aligned, individual waveplates 720a, 720b, and 720c, formed from, preferably, birefringent crystal (similar to waveplate filter 40 of FIG. 4). While waveplate filter 720 is depicted in FIG. 7 as being comprised of three waveplates (720a, 720b, and 720c), it should be understood that waveplate filter 720 may comprise any number of individual waveplates.

In addition to waveplate filter 720, the exemplary device of FIG. 7 further comprises waveplate filters 730 and 760, each of waveplate filters 730 and 760 themselves being comprised, preferably, of a plurality of individual waveplates formed from birefringent crystal. In the embodiment of FIG. 7, waveplate 730 is comprised of individual waveplates 730a, 730b, and 730c, while waveplate 760 is comprised of individual waveplates 760a, 760b, and 760c. As was the case with respect to waveplate filter 720, it should be understood that although waveplate filters 730 and 760 are depicted in FIG. 7 as being made of three individual waveplates, these filters may comprise any number of individual waveplates. Moreover, waveplate filters 720, 730, and 760 may each include a different number of individual waveplates (as opposed to having an equal number of waveplates as depicted in FIG. 7).

Each of the individual waveplates of waveplate filters 720, 730, and 760 includes, has, or is implemented with a particular crystal rotation angle (i.e., the rotation angle of FIG. 1). To aid in the demonstration of the operation of the exemplary device of FIG. 7, as well as in demonstrating embodiments of the method of the present invention, the individual waveplates of the waveplate filters of FIG. 7 are identified or labeled with a crystal angle variable. For example, in FIG. 7, the individual crystal waveplates of waveplate filter 720 are each labeled with a crystal angle variable Aₓ, where A represents the rotation angle of the crystal element and x represents the particular crystal element's order within the propagation paths of the beam signals entering the waveplate filter (e.g., 720a is labeled A₁, 720b is labeled A₂, 720c is labeled A₃). Likewise, the crystal waveplates of waveplate filter 760 are each labeled with a crystal rotation angle variable B_{y}, where B represents the rotation angle of the crystal element and y represents the particular crystal element's order within the propagation paths of the beam signals entering the waveplate filter (e.g., 760a is labeled B₁, 760b is labeled B₂, and 760c is labeled B₃). Similarly, the crystal waveplates of waveplate filter 730 are each labeled with a crystal rotation angle variable CZ, where C represents the rotation angle of the crystal element and z represents the particular crystal element's order within the propagation paths of the beam signals entering the waveplate filter (e.g., 730a is labeled C₁, 730b is labeled C₂, and 730c is labeled C₃).

Furthermore, each of waveplate filters 720, 730, and 760 may receive a signal(s) having a particular polarization(s) and output a signal(s) having the same or different polarization(s) as the received signal(s). Similar to the crystal angle variables above, to aid in the demonstration of the operation of the exemplary device of FIG. 7, as well as in demonstrating embodiments of the method of the present invention, polarization indicators appear above and below the waveplate filters 720, 730 and 760 in FIG. 7. This placement of the indicators above and below the filters of FIG. 7 is arbitrary and the proximity of an indicator toward a particular propagation path of a waveplate filter does not signal that the polarization transition indicated by the proximate indicator is the only polarization transition occurring along that propagation path.

These input-output polarization indicators are, preferably, in the form of “Xₙₐ-Yₙₐ” and “X_{nb}-Y_{nb}”, X signifying the polarization of an input beam signal entering an optical component at a point along a particular propagation path, Y signifying the polarization of an output beam signal exiting the optical component at a point along the same propagation path, and n is an arbitrary number assigned to the particular optical component. For example, in FIG. 7, the input-output polarization indicators for waveplate filter 720 are X₁ₐ-Y₁ₐ and X_{1b}-Y_{1b}; X₂ₐY₂ₐ and X_{2b}-Y_{2b} for waveplate filter 730; and X₃ₐ-Y₃ₐ and X_{3b}-Y_{3b} for waveplate filter 760. For the polarization indicators of FIG. 7, if X equals Y, then no polarization transition occurs along that particular propagation path. On the other hand, if X does not equal Y, then a polarization transition does occur along that particular path. Preferably, an input-output polarization indicator will read either E-E, E-O, O-E, or O-O. Similar to the case with respect to the dispersion matrices of FIGS. 2 and 3, E-E and O-O signify that no polarization transition has occurred. Likewise, E-O and O-E signify that a polarization transition has occurred.

As previously discussed, a waveplate filter normally fashions two output signals (i.e., two polarizations) for each input signal. The first output signal (or first polarization) comprises a first sub-spectrum of the input signal having the same polarization as the input signal, and the second output signal (or second polarization) comprises a complementary sub-spectrum at the orthogonal polarization. Thus, in FIG. 7, output signals 722 (corresponding to input signal 714) and 723 (corresponding to input signal 708), formed by virtue of waveplate filter 720, have the same polarization as their respective corresponding input signals, while output signals 724 (corresponding to input signal 714) and 725 (corresponding to input signal 708), also formed by virtue of waveplate filter 720, have a polarization orthogonal to that of their respective corresponding input signals.

Next, signals 722, 723, 724 and 725 are communicated to two polarization beams splitters 727 and 749 that separate signals 722, 723, 724 and 725 according to polarization. Thus, signals 722 and 723 having a first polarization, that being the same polarization as that of input signals 708 and 714, are allowed to pass onto waveplate filter 730. Meanwhile, signals 724 and 725 having a different polarization, that being orthogonal to that of input signals 708 and 714, are directed toward waveplate filter 760.

After signals 722, 723, 724, and 725 are separated by beam splitters 727 and 749, signals 722 and 723 are then passed through stacked waveplate filter 730 which, as mentioned, is preferably made up of a plurality of substantially aligned individual waveplates 730a, 730b, and 730c. Also as mentioned, the individual waveplates of filter 730 (i.e., 730a, 730b, and 730c) each have a crystal rotation angle, which, for demonstration purposes, is indicated by or labeled with the angle variable C_{Z}. Moreover, waveplate filter 730 produces a particular polarization transition(s), or lack thereof, which, as mentioned earlier, for demonstrations purposes, is indicated in FIG. 7 by a polarization indicator(s) placed above and/or below filter 730.

For reasons discussed earlier with respect to waveplate filters, the output signals of waveplate filter 730 are two sets of signals having orthogonal polarizations. Signal 731 (corresponding to incoming signal 722) and signal 732 (corresponding to incoming signal 723) have the same polarization as that of signals 722 and 723. Signal 733 (corresponding to signal 722) and signal 734 (corresponding to incoming signal 723), on the other hand, have a polarization orthogonal to that of signals 722 and 723.

Beam displacer 740 is capable of combining at least two of signals 731, 732, 733, and 734. However, to combine two of these signals without energy loss, additional structures should be combined with displacer 740. For example, to combine signals 733 and 734 (which have the same polarization and are spatially separated) without energy loss, as is done in the embodiment of FIG. 7, the polarization of one of these signals should be changed. Accordingly, in the particular configuration of FIG. 7, signal 733 passes through half-waveplate 736, whereby its polarization is then changed to an orthogonal polarization. The resulting signal is then designated as signal 742. Meanwhile, signal 734 is passed through glass 738 to compensate for the index difference between the propagation paths of the two signals (e.g., path 710-712-720-730 for signal 733 and path 710-720-730 for signal 734), although glass 738 is not necessary in order to combine the signals. After passing through glass 738, the polarization of signal 738 is unchanged, however, the signal is now designated as signal 744. Signal 744 (with its original polarization) and signal 742 (with an orthogonal polarization) are combined in beam displacer 740, and the resulting signal is designated 746. Signal 746 is then passed through collimator 748 to enter optical fiber, systems, or network. Note that structures 736 and 738, as well as the arrangement of these structures, are included in FIG. 7 by way of example only, for different arrangements of the structures, as well as different structures all together, may be included in FIG. 7 (e.g., when combining signals 731 and 732 in beam displacer 740 without loss)

With respect to signals 724 and 725, in the particular configuration of FIG. 7, after being separated from signals 722 and 723 by the polarization beam splitters, these signals are passed through stacked waveplate filter 760, which, as mentioned, is made up of a plurality of substantially aligned individual waveplates 760a, 760b, and 760c. Also as mentioned, the individual waveplates of filter 760 (i.e., 760a, 760b, and 760c) each have a crystal rotation angle, which, for demonstration purposes, is indicated by or labeled with the angle variable B_{y}. Moreover, waveplate filter 760 produces a particular polarization transition(s), or lack thereof, which, for demonstrations purposes, is indicated in FIG. 7 by a polarization indicator(s) placed above and/or below filter 760.

As was the case with waveplate filters 720 and 730, the output signals of stacked waveplate filter 760 corresponding with incoming signals 724 and 725 are two sets of two signals with orthogonal polarizations. The output signals corresponding with signal 724 are signal 764 (having the same polarization as signal 724) and signal 762 (having a polarization orthogonal to that of signal 724). The output signals corresponding with signal 725 are signal 765 (having the same polarization as signal 725) and signal 763 (having a polarization orthogonal to that of signal 765).

Like beam displacer 740, beam displacer 770 is capable of combining at least two of signals 762, 763, 764, and 765. However, to combine two of these signals without energy loss, additional structures should be combined with displacer 770. For example, to combine signals 762 and 763 (which have the same polarization and are spatially separate) without energy loss, as is done in the embodiment of FIG. 7, the polarization of one of these signals should be changed. Accordingly, in FIG. 7, signal 763 passes through half-waveplate 768 whereby its polarization is changed to an orthogonal polarization. The resulting signal is designated as signal 774. Signal 762 enters beam displacer 770 with its polarization unchanged, however, signal 762 is now designated as signal 772. Signal 772 (with its original polarization) and signal 774 (with an orthogonal polarization) are combined in beam displacer 770, and the resulting signal is designated as signal 776. The signal 776 is then passed through collimator 778 to enter optical fiber, systems, or network. Note that structure 768, as well as the arrangement of the structure, is included in FIG. 7 by way of example only, for different arrangements of the structure, as well as a different structure(s) all together, may be included in FIG. 7 (e.g., when combining signals 764 and 765 in beam displacer 770 without loss).

In addition, all optical signals propagating within an optical device (i.e., between the inputs(s) and the output(s) of the optical device) may be referred to as intermediate optical signals. For example, in the embodiment of FIG. 7, signals propagating within or between beam displacer 710, beam displacer 740, and beam displacer 770 respectively may be referred to as intermediate optical signals. Particularly, all optical signals propagating within or between beam displacer 710 and beam splitter 727, all optical signals propagating within or between beam splitter 727 and beam displacer 740, all optical signals propagating within or between beam splitters 727 and 749, and all optical signals propagating within or between beam splitter 749 and beam displacer 770 may be referred to as intermediate optical signals.

Under at least one embodiment of a method of the present invention, the dispersion characteristic(s) that may be introduced by the device depicted in FIG. 7 onto optical signals passing therethrough may be tailored or managed by configuring/arranging the rotation angles of the first crystal plates of waveplate filters 720, 730, and 760 (e.g., A₁, B₁, and C₁), by arranging/managing the polarizations of the signals entering waveplate filters 720, 730, and 760, and/or through arranging/managing the polarization transitions occurring within waveplate filters 720, 730, and 760, in a manner providing for the desired characteristics. An example of an embodiment of the exemplary device of FIG. 7 configured, arranged, designed, etc., under an embodiment of a method of the present invention such that signals exiting the device at either P1 or P2 exhibit substantially zero dispersion as a result of the device (i.e., arrange the device such that it is dispersion free) is shown in FIG. 8. One example of how the device of FIG. 8 may be accomplished using an embodiment of a method of the present invention is provided below.

To accomplish the device of FIG. 8 following an embodiment of the method of the present invention, e.g., the embodiment depicted in FIG. 6, since the device and the desired dispersion characteristic(s) have already been determined, in the embodiment of FIG. 6, the next step is to determine the input polarization(s) of the signals entering waveplate 820, waveplate filter 820 being the first optical component, as described earlier with respect to FIG. 6, in this embodiment. Waveplate filter 820, in at least one embodiment, comprises individual waveplates 820a, 820b, and 820c made from birefringent crystal.

As evidenced in FIG. 8, it is decided that beam signals 808 and 814 entering the waveplate filter 820 shall have an extraordinary polarization (this is represented by an “E” in FIG. 8, while an ordinary polarization is represented by an “O”). To achieve this, half-wave plate 812 is implemented so as to change the polarization of signal 806, which results from birefringent element 810 decomposing an input signal 800 passing along fiber 802 and through collimator 804 into signal 806 having an ordinary polarization and a signal 808 having an extraordinary polarization, from an ordinary to an extraordinary polarization (now designated as signal 814). As a result, the input-output polarization indicators located above and below waveplate 820 in FIG. 8, whose purpose, as mentioned earlier, is to aid in demonstrating the operation of the device, indicate an E input polarization.

If the input polarizations for waveplate 820 have been determined, then the output polarizations may be determined as well. As mentioned, a waveplate filter normally fashions two output signals from each original input signal. The first output signal comprises a first sub-spectrum of the input signal with the same polarization as the input signal, and the second output signal comprises a complementary sub-spectrum at the orthogonal polarization. Thus, in FIG. 8, output signals 822 (corresponding to input signal 814) and 823 (corresponding to input signal 808) have extraordinary (E) polarizations, while output signals 824 (corresponding to input signal 814) and 825 (corresponding to input signal 808) have ordinary (0) polarizations. Accordingly, the polarization indicators for waveplate filter 820 indicate waveplate filter 820 transforms a signal having an E polarization into a first sub-spectrum having an E polarization and a complementary sub-spectrum having an O polarization (i.e., E-E and E-O).

In at least one embodiment, once the input-output polarizations of waveplate filter 820 are ascertained, the rotation angle of the first crystal element of waveplate filter 820 (i.e., the rotation angle for waveplate 820a) that enables a desired dispersion characteristic(s) may be selected/determined. For purposes of this example, suppose for some reason it is desired that waveplate filter 820 introduce a “+” signed dispersion onto signals experiencing an E-E transition within waveplate filter 820 and a “−” signed dispersion onto signals experiencing an E-O transition within the filter. However, as was described earlier, in at least one embodiment, waveplate filter 820, along with the polarizations of input signals 814 and 808, may be configured to achieve any one of a number of signed dispersion characteristics to include at least one “+” signed dispersion characteristic(s) and/or at least “−” signed dispersion characteristic(s) for signals exiting waveplate filter 820.

The rotation angle that provides for this desired dispersion property for the desired dispersion characteristics given the polarization of the signals entering filter 820 and the polarization transitions occurring within filter 820 is preferably determined using the properties shown in a dispersion matrix, such as the properties shown in dispersion matrices of FIGS. 2 and 3. In one embodiment, since the matrix of FIG. 2 provides dispersion properties with respect to an optical component having three crystal elements, the properties shown in the matrix of FIG. 2 are used, at least in part, to determine the rotation angle for waveplate 820a. The properties shown in the matrix of FIG. 2 disclose that a rotation angle of “a” for waveplate 820a would enable the desired dispersion property given the input polarizations and polarization transitions previously determined. Furthermore, as mentioned earlier, a 35° angle qualifies as angle “an” of the matrix of FIG. 2. Thus, a rotation angle of 35° is selected for waveplate 820a. For the same reasons, a rotation angle of −76° is chosen for waveplate 820b, as well as a rotation angle of −64° for waveplate 820c.

Although in the present example, the properties shown in the matrix of FIG. 2 were chosen to aid in configuring the device on the basis that they are provided in a matrix relating to an optical component having three crystal elements, the device of FIG. 8 may be accomplished using properties shown in dispersion matrices relating to optical components having more or less than three crystal elements. Since in at least one embodiment of the present invention, it is the rotation angle of the first crystal element that affects the dispersion property, the device of FIG. 8 may be accomplished using dispersion properties provided in a dispersion matrix relating to an optical component having one or more crystal elements.

As mentioned, under the properties shown in the matrix of FIG. 2, an E-E input-output polarization combined with a first crystal angle of “a” (e.g., 35°) means a signed dispersion characteristic, while an E-O input-output polarization combined with a first crystal rotation angle of a (e.g., 35°) means a “−” signed dispersion characteristic. Accordingly, waveplate filter 820 introduces a “+” signed dispersion of a certain magnitude onto signals 822 and 823, while introducing a “−” signed dispersion of a certain magnitude onto signals 824 and 825.

Consequently, to achieve the desired dispersion characteristic(s), which in this instance is zero dispersion at P1 and P2, the dispersion resulting from waveplate filter 820 discussed above must be compensated for in some manner. One way in which to do this is to have waveplate filters 830 and 860 provide dispersion that is approximately equal in magnitude, but opposite in sign, compared to that which is introduced by waveplate filter 820 (filters 830 and 860, in this instance, qualifying as additional optical components in the device that are capable of introducing dispersion onto optical signals passing through the device). Accordingly, since the dispersion characteristic introduced onto signals 822 and 823 is “+” signed, at least a portion of the dispersion characteristic introduced by waveplate filter 830 should be “−” signed. Likewise, since the dispersion characteristic introduced onto signals 824 and 825 is “−” signed, at least a portion of the dispersion introduced by waveplate filter 860 should be “+” signed.

Waveplate filters 830 and 860, in at least one embodiment, comprise a plurality of individual waveplates made from birefringent crystal (i.e., in the case of waveplate filter 830, waveplates 830a, 830b, and 830c, while in the case of waveplate filter 860, waveplates 860a, 860b, and 860c). In at least one embodiment of the present invention, the first step in determining how waveplate filters 830 and 860 may compensate for the dispersion characteristics introduced by waveplate filter 820 is to determine the input-output polarizations for signals passing through waveplate filters 830 and 860. With respect to the input polarizations, after signals 822, 823, 824, and 825 exit waveplate filter 820, polarization beam splitters 827 and 849 separate the signals according to polarization. As a result, those signals having an E polarization (signals 822 and 823) would be allowed to pass onto waveplate filter 830. On the other hand, those signals having an O polarization (signals 824 and 825) would be directed to waveplate filter 860. Thus, the input polarization for the signals entering waveplate filter 830 is E, while the input polarization for the signals entering waveplate filter 860 is O.

With respect to the output polarizations of the signals passing through waveplate filters 830 and 860, for reasons discussed earlier, signal 822 entering waveplate filter 830 having an E polarization will be decomposed into signal 831 having an E polarization and signal 833 having an O polarization. Similarly, signal 823, also entering waveplate filter 830 having an E polarization will be decomposed into signal 832 having an E polarization and signal 834 having an O polarization. Hence, the polarization indicators above and below waveplate filter 830 in FIG. 8 read E-E and E-O.

In addition, for the same reasons signals 822 and 823 are transformed in the manner that they are, signal 824 entering waveplate filter 860 having an O polarization will be decomposed into signal 862 having an E polarization and signal 864 having an 0 polarization. Likewise, signal 825, also entering waveplate filter 860 having an 0 polarization, will be decomposed into signal 863 having an E polarization and signal 865 having an O polarization. Hence, the polarization indicators above and below waveplate filter 860 in FIG. 8 read O-O and O-E.

Now that the input-output polarizations for the signals propagating through waveplate filters 830 and 860 are known, the rotation angles for waveplates 830aand 860a (i.e., rotation angles for the first crystal elements of these filters) that would provide for the desired oppositely signed dispersion characteristics may be determined. In one embodiment, this is accomplished using the dispersion properties provided by a dispersion matrix, such as the properties shown in the dispersion matrices of FIGS. 2 and 3. For the same reasons the properties shown in the dispersion matrix of FIG. 2 were used to determine the rotation angle for 820a, the properties shown in the dispersion matrix of FIG. 2 are used to determine the rotation angles for 830aand 860a. However, as previously mentioned, the dispersion properties shown in any one of a plurality of dispersion matrices or combination of matrices may be used to determine the rotation angles that provide for the oppositely signed dispersion given the previously determined input and output polarizations.

With respect to waveplate filter 830, according to the dispersion properties provided by the matrix of FIG. 2, when the polarization for a signal entering an optical component is extraordinary (E), such as the situation for signals 822 and 823 entering waveplate filter 830, in order for an optical component to introduce a “−” signed dispersion characteristic onto the outgoing signals, the rotation angle set for waveplate filter 830 should be “a-b-c” (e.g., 35°, −76°, and −64°), rather than “c-b-a”. According to the properties shown in the matrix of FIG. 2, rotation angle set “c-b-a” will not provide the desired “−” signed dispersion, given an E input polarization.

Accordingly, in the example of FIG. 8, waveplate filter 830 is designed, assembled, arranged, etc., such that the particular rotation angles for waveplates 830a, 830b, and 830c qualify as crystal rotation angle set “a-b-c” of the matrix of FIG. 2 (particularly, a rotation angle of 35° for waveplate 830a, a rotation angle of −76° for waveplate 830b, and a rotation angle of −64° for waveplate 830c). As a result, under the properties shown in FIG. 2, waveplate filter 830 introduces a “+” signed dispersion characteristic onto signals 831 and 832, since the input-output polarization for these signals is E-E and the rotation angle set for waveplate filter 830 qualify as crystal rotation angle set “a-b-c”. Similarly, waveplate filter 830 introduces a “−” signed dispersion characteristic onto signals 833 and 834, since the input-output polarization for these signals is E-O and the rotation angle set through which these signals pass qualify as crystal angle set “a-b-c”.

Because, as discussed above, a “+” signed dispersion characteristic is introduced onto signals 822 and 823 by virtue of waveplate filter 820, in order to achieve the desired dispersion characteristic of zero dispersion at P1, a “−” signed dispersion characteristic should be imparted to compensate for the already imparted “+” signed dispersion characteristic. In the exemplary device of FIG. 8, signal 833, which is formed from signal 822 and thus already has the “+” signed dispersion characteristic of signal 822 imparted to it, has a “−” signed dispersion characteristic imparted to it by virtue of waveplate filter 830. Likewise, signal 834, which is formed form signal 823 and thus already has the “+” signed dispersion characteristic of signal 823 imparted to it, also has a “−” signed dispersion characteristic imparted to it by virtue of waveplate filter 830. Therefore, signals 833 and 834 are desired.

As a result, the device of FIG. 8 is configured such that signals 833 and 834 are combined by beam displacer 840 without energy loss. Particularly, signal 833 (with O polarization) becomes signal 842 (with E polarization) after it passes through half-waveplate 836. Moreover, to compensate for the index difference between the respective paths of the two signals, signal 834 passes through glass 838 where it becomes signal 844. Signals 842 and 844 are then combined in beam displacer 840 into signal 846. Signal 846 is then passed through collimator 848 to enter optical fiber, systems, or network via P1. Since signal 846 is the result of a combination of signals onto which roughly equal amounts of “+” and “−” dispersion have been introduced, signal 846 exiting the device at outport P1 exhibits little or no dispersion, and thus, the desired dispersion characteristic with respect to P1 is achieved.

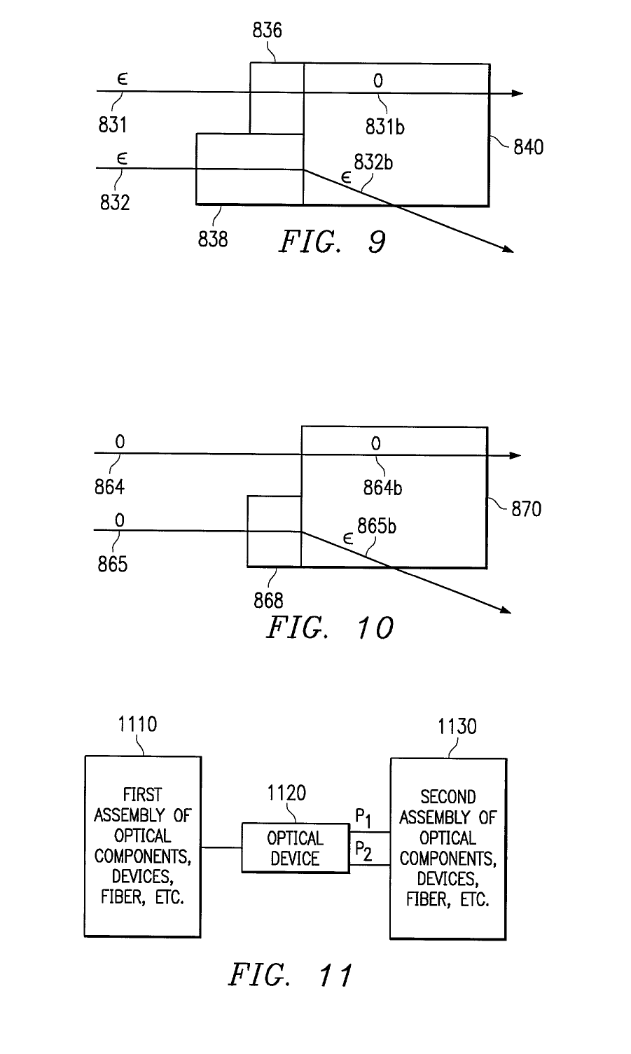

Moreover, in the particular configuration of FIG. 8, signals 831 and 832 (with E polarization) diverge after they pass through half-waveplate 836 and beam displacer 840 and glass 838 and beam displacer 840 respectively. As shown in FIG. 9, the signal 831 (with E polarization) becomes signal 831b (with O polarization) after it passes through half-waveplate 836. In addition, signal 832 (with E polarization) becomes signal 832b (with E polarization) after it passes through the glass 838. As shown in FIGS. 8 and 9, the signals 831b and 832b will not converge or otherwise interfere with signals 842 and 844 in beam displacer 840. Therefore, their effects are not taken into account.

Meanwhile, with respect to waveplate filter 860, according to the properties shown in the matrix of FIG. 2, when the polarization for a signal entering an optical component is ordinary (O), such as the situation for signals 824 and 825 entering waveplate 860, in order for an optical component to introduce a “+” signed dispersion characteristic onto the outgoing signals, the rotation angle set for waveplate filter 860 should be “a-b-c”, rather than “c-b-a”. According to the properties shown in the matrix, rotation angle set “c-b-a” will not provide the desired “+” signed dispersion, given an O input polarization.

Accordingly, in the example of FIG. 8, waveplate filter 860 is designed, assembled, arranged, etc., such that the rotation angles for waveplates 860a, 860b, and 860c qualify as the crystal rotation angle set “a-b-c” of the matrix of FIG. 2 (particularly, a rotation angle 35° for waveplate 860a, a rotation angle of −76° for waveplate filter 860b, and a rotation angle of −64° for waveplate filter 860c). As a result, under the properties shown in FIG. 2, waveplate filter 860 introduces a “−” signed dispersion characteristic onto signals 864 and 865, since the input-output polarization for these signals is O-O and the values of the angle set through which these signals pass qualify as crystal rotation angle set “a-b-c”. Similarly, waveplate filter 860 introduces a “+” signed dispersion characteristic onto signals 862 and 863, since the input-output polarization for these signals is O-E and the angle set through which these signals pass qualify as crystal rotation angle set “a-b-c”.

Similar to the situation with respect to waveplate filter 830, because a “−” signed dispersion characteristic is introduced onto signals 824 and 825 by virtue of waveplate filter 820, in order to achieve the desired dispersion characteristic of zero dispersion at P2, a “+” signed dispersion characteristic should be imparted to compensate for the already imparted “−” signed dispersion characteristic. In the exemplary device of FIG. 8, signal 862, which is formed from signal 824 and thus already has the “−” signed dispersion characteristic of signal 824 imparted to it, has a “+” signed dispersion characteristic imparted to it by virtue of waveplate filter 860. Likewise, signal 863, which is formed form signal 825 and thus already has the “−” signed dispersion characteristic of signal 825 imparted to it, also has a “+” signed dispersion characteristic imparted to it by virtue of waveplate filter 860. Therefore, signals 862 and 863 are desired.

As a result, the device of FIG. 8 is configured such that signals 862 and 863 are combined by beam displacer 870 without energy loss. Particularly, signal 863 (with E polarization) becomes signal 874 (with O polarization) after it passes through half-waveplate 868. Signal 862 (with E polarization) enters beam displacer 870 where it becomes signal 872 (with E polarization). Signals 872 and 874 are then combined in beam displacer 870 into signal 876. Signal 876 is then passed through collimator 878 to enter optical fiber, systems, or network via P2. Since signal 876 is the result of a combination of signals onto which roughly equal amounts of “+” and “−” dispersion has been introduced, signal 876 exiting the device at outport P2 exhibits little or no dispersion, and thus, the desired dispersion characteristic with respect to P2 is achieved as well.

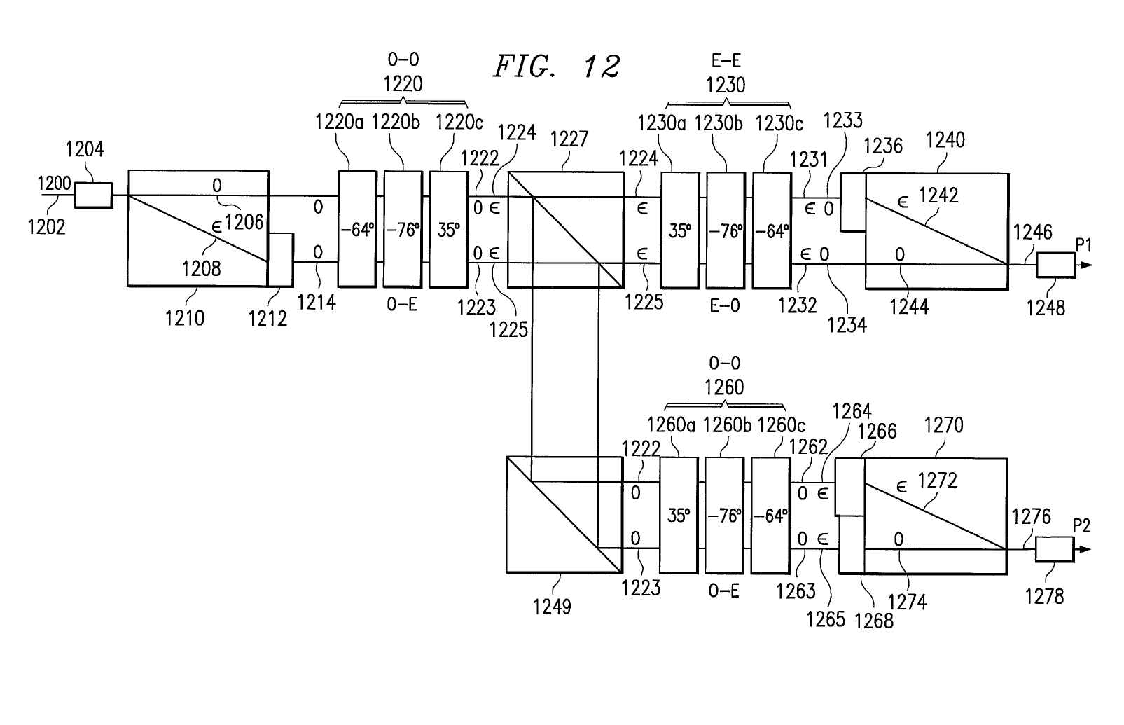

Moreover, in the particular configuration of FIG. 8, signals 864 and 865 (with O polarization) diverge after they pass through beam displacer 870 and/or half-waveplate 868 respectively. As shown in FIG. 10, signal 865 (with O polarization) becomes signal 865b (with E polarization) after it passes through half-waveplate 868. In addition, signal 864 (with O polarization) becomes signal 864b (with O polarization) after it enters beam displacer 870. As shown in FIGS. 8 and 10, the signals 864b and 865b will not converge or otherwise interfere with the signals 872 and 874 in the beam displacer 870. Therefore, their effects are not taken into account.

It is not required that in all instances the rotation angle of the first crystal element of all of the optical components of the device be the same. In this particular instance, it just happens that under the properties shown in the matrix of FIG. 2, given the fact that the input polarization of signals entering waveplate filter 820 is E, having a rotation angle of 35° for waveplates 820a, 830a, and 860a achieves the desired optical characteristics.

Although as demonstrated above, an embodiment of the method of the present invention may be used to design or assemble optical devices wherein the dispersion that might normally be introduced onto optical signals by such devices is canceled out or compensated for by virtue of the configuration of these devices, the above method may also be used to design and/or assemble optical devices configured such that a desired magnitude of dispersion (in this instance, a magnitude other than zero) is purposely introduced onto a signal passing through the device.

To illustrate, FIG. 11 depicts an optical communication system comprising a first assembly of optical components, devices, fiber, etc. 1110, a dispersion tailoring optical device 1120 having two outputs P1 and P2 (such as the exemplary device of FIG. 7), and a second assembly of optical components, devices, fiber, etc. 1130. First and second assemblies of optical components, etc. 1110 and 1130 may include any component, device, fiber, etc. used in optical communications systems, now known or later developed, to include such potentially dispersion introducing components as amplifiers, multiplexers, demultiplexers, equalizers, routers, switches, hubs, bridges, waveplates, beam displacers, polarization beam splitters, glasses, combinations thereof, etc. In the optical communication system of FIG. 11, the dispersion tailoring optical device 1120 may be configured, arranged, etc. according to an embodiment of the present invention to provide a desired magnitude of dispersion having a particular slope to compensate for dispersion introduced on to signals by either first assembly 1110 or second assembly 1130.

For example, suppose it is known that a substantial amount of “+” signed dispersion will be introduced onto a signal upon its entry into second assembly 1130. This substantial amount of “+” signed dispersion may be the result of such things as optic fiber or an optical component(s), such as one of the potential dispersion introducing components listed above, within second assembly 1130. Accordingly, it may be advantageous to configure dispersion tailoring optical device 1120 such that device 1120, rather than compensating for dispersion that may be introduced by device 1120, instead introduces a desired magnitude (e.g., an amount roughly equal to the magnitude of the “+” signed dispersion) of “−” signed dispersion onto a signal exiting optical device 1120 that will form at least a portion of the signal onto which the “+” signed dispersion will be introduced by second assembly 1130. Then, the substantial “+” signed dispersion, rather than hindering the signal, now compensates for the dispersion introduced by optical device 1120. Therefore, suppose that it is desired that device 1120 introduce a substantial amount of “−” dispersion onto at least one signal exiting device 1120 at output P1 and zero dispersion on at least one signal exiting device 1120 at P2. An optical device may be configured to achieve this desired dispersion characteristic through an embodiment of the method of the present invention.

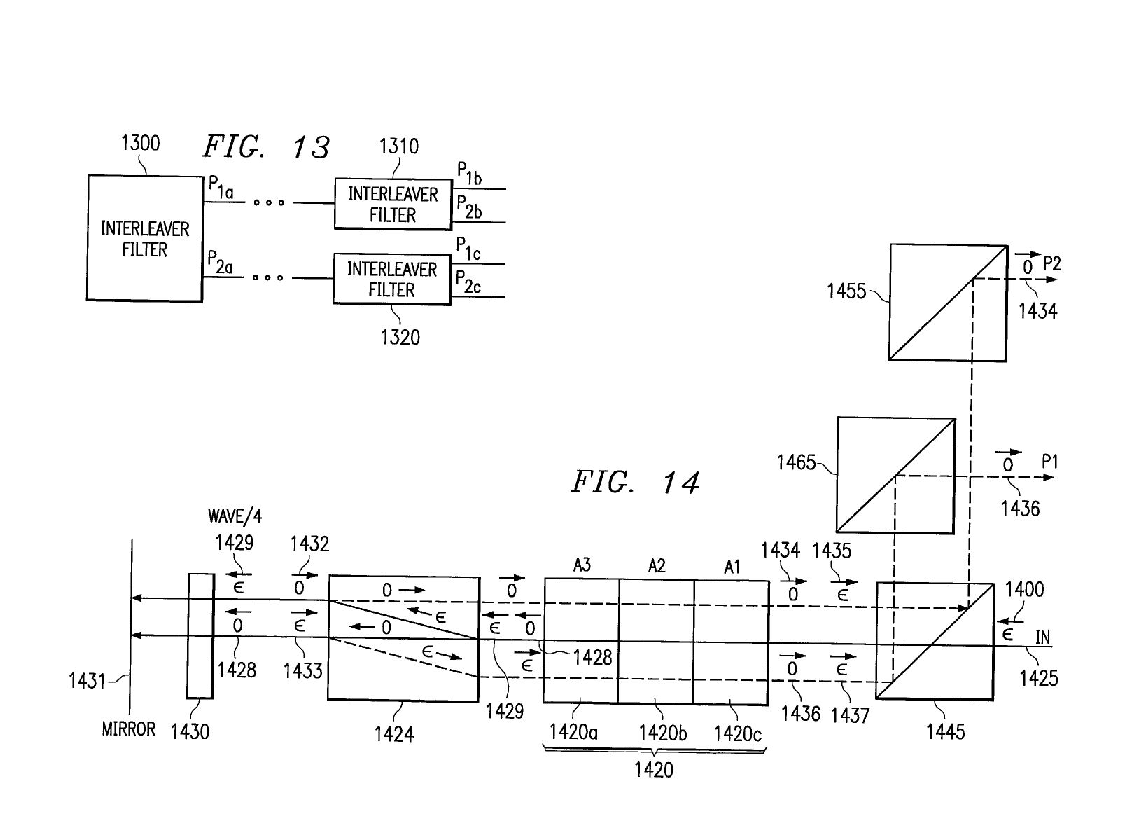

FIG. 12 shows an embodiment of the exemplary device of FIG. 7 configured, arranged, etc., through an embodiment of the method of the present invention to achieve the desired dispersion characteristic of the above example. One example of how the device of FIG. 12 may be accomplished using an embodiment of a method of the present invention is provided below.

To accomplish the device of FIG. 12 following an embodiment of the method of the present invention, e.g., the embodiment of FIG. 6, since the device and the desired dispersion characteristic(s) for the device have already been determined, in the embodiment of FIG. 6, the next step is to determine the input polarization(s) of the signals entering waveplate 1220, waveplate filter 1220 being the first optical component, as described earlier with respect to FIG. 6, in this instance. Waveplate filter 1220, in at least one embodiment, comprises individual waveplates 1220a, 1220b, and 1220c made from birefringent crystal (similar to waveplate 40 of FIG. 4).

As evidenced in FIG. 12, it is decided that beam signals 1206 and 1214 entering waveplate filter 1220 shall have an O polarization. An O polarization for signals 1206 and 1214 are selected because, under the properties shown in the matrix of FIG. 2, an O polarization provides more options for achieving a “−” signed dispersion characteristic than E.

To achieve O polarization for signals 1206 and 1214, half-wave plate 1212 is implemented so as to change the polarization of signal 1208, which results from birefringent element 1210 decomposing input signal 1200 passing along fiber 1202 and through collimator 1204 into signal 1206 having an O polarization and a signal 1208 having an E polarization, from an E to an O polarization (now designated as signal 1214). As a result, the input-output polarization indicators located above and below waveplate 1220 in FIG. 12, whose purpose, as mentioned earlier, is to aid in demonstrating the operation of the device, indicate an O input polarization.

If the input polarizations for waveplate 1220 have been determined, then the output polarizations may be determined as well. As mentioned, a waveplate filter normally fashions two output signals from each original input signal. The first output signal comprises a first sub-spectrum of the input signal with the same polarization as the input signal, and the second output signal comprises a complementary sub-spectrum at the orthogonal polarization. Thus, in FIG. 12, output signals 1222 (corresponding to input signal 1206) and 1223 (corresponding to input signal 1214) have O polarizations, while output signals 1224 (corresponding to input signal 1206) and 1225 (corresponding to input signal 1214) have E polarizations. Accordingly, the polarization indicators for waveplate filter 1220 indicate waveplate filter 1220 transforms a signal having an O polarization into a first sub-spectrum having an O polarization and a complementary sub-spectrum having an E polarization (i.e., O-O and O-E).

In at least one embodiment, once the input-output polarizations of waveplate filter 1220 are ascertained, the rotation angle of the first crystal element of waveplate filter 1220 (i.e., the rotation angle for waveplate 1220a) may be selected/determined. In this example, as mentioned, it is desired that a substantial amount of “−” signed dispersion be introduced onto at least one signal exiting at output P1 of the device. Accordingly, it is desired that a “−” signed dispersion characteristic be introduced onto those signals resulting from waveplate filter 1220 that at least contribute to those signals exiting the device at P1. Hence, it is desired that a “−” signed dispersion characteristic be introduced onto signal 1224 and 1225. However, as was described earlier, in at least one embodiment, waveplate filter 1220, along with the polarizations of input signals 1214 and 1206, may be configured to achieve any one of a number of signed dispersion characteristics to include at least one “+” signed dispersion characteristic(s) and/or at least “−” signed dispersion characteristic(s) for signals exiting waveplate filter 1220.

The rotation angle for waveplate 1220a that provides for this desired dispersion property for the desired dispersion characteristics given the polarization of the signals entering filter 1220 and the polarization transitions occurring within filter 1220 is, in at least one embodiment, determined using the properties shown in a dispersion matrix, such as the properties shown in the dispersion matrices of FIGS. 2 and 3. In one embodiment, since the matrix of FIG. 2 provides dispersion properties relating to an optical component having three crystal elements, the properties shown in the matrix of FIG. 2 are used, at least in part, to determine the rotation angle for waveplate 1220a. The properties shown in the matrix of FIG. 2 disclose that a rotation angle of “c”, rather than “a”, for waveplate 1220a would enable the desired dispersion characteristics given the input polarizations and polarization transitions previously determined. Furthermore, as mentioned earlier, a −64° angle qualifies as angle “c” of the matrix of FIG. 2. Thus, a rotation angle of −64° is selected for waveplate 1220a. For the same reasons, a rotation angle of −76° is chosen for waveplate 1220b, as well as a rotation angle of 35° for waveplate 1220c.

With a value of −64° selected for waveplate 1220a, under the properties shown in the matrix of FIG. 2, waveplate filter 1220 introduces a “−” signed dispersion characteristic onto signals 1222, 1223, 1224, and 1225.

Consequently, to achieve the desired dispersion characteristic(s), which in this instance is substantial “−” signed dispersion at P1 and zero dispersion at P2, the “−” signed dispersion resulting from waveplate filter 1220 should be increased in some manner by waveplate filter 1230 and compensated for in some manner by waveplate filter 1260. One way in which to do this is to have waveplate filter 1260 provide at least one dispersion characteristic that is equal in magnitude, but opposite in sign, compared to that which is introduced by waveplate filter 1220, while having waveplate filter 1230 provide dispersion that is equal in both magnitude and sign to that which is introduced by waveplate filter 1220 (filters 1230 and 1260, in this instance, qualifying as additional optical components in the device that are capable of introducing dispersion onto optical signals passing through the device). Accordingly, since the dispersion introduced onto signals 1222 and 1223 is “−” signed, at least a portion of the dispersion characteristics introduced by waveplate filter 1260 should be “+” signed. Likewise, since the dispersion introduced onto signals 1224 and 1225 is “−” signed, at least a portion of the dispersion characteristic introduced by waveplate filter 1230 should be also be “−” signed.

Waveplate filters 1230 and 1260, in at least one embodiment, comprise a plurality of individual waveplates made from birefringent crystal (i.e., in the case of waveplate filter 1230, waveplates 1230a, 1230b, and 1230c, while in the case of waveplate filter 1260, waveplates 1260a, 1260b, and 1260c). In at least one embodiment of the present invention, the first step in determining how waveplate filters 1230 and 1260 may provide for the desired dispersion characteristics is determining the input-output polarizations for signals passing through waveplate filters 1230 and 1260. With respect to the input polarizations, after signals 1222, 1223, 1224, and 1225 exit waveplate filter 1220, polarization beam splitters 1227 and 1249 separate the signals according to polarization. As a result, those signals having an E polarization (signals 1224 and 1225) would be allowed to pass onto waveplate filter 1230. On the other hand, those signals having an O polarization (signals 1222 and 1223) would be directed to waveplate filter 1260. Thus, the input polarization for the signals entering waveplate filter 1230 is E, while the input polarization for the signals entering waveplate filter 1260 is O.

With respect to the output polarizations of the signals passing through waveplate filters 1230 and 1260, for reasons discussed earlier, signal 1224 entering waveplate filter 1230 having an E polarization will be decomposed into signal 1231 having an E polarization and signal 1233 having an O polarization. Similarly, signal 1225, also entering waveplate filter 1230 having an E polarization, will be decomposed into signal 1232 having an E polarization and signal 1234 having an O polarization. Hence, the polarization indicators above and below waveplate filter 1230 in FIG. 12 read E-E and E-O.

In addition, for the same reasons signals 1224 and 1225 are transformed in the manner that they are, signal 1222 entering waveplate filter 1260 having an O polarization will be decomposed into signal 1262 having an O polarization and signal 1264 having an E polarization. Likewise, signal 1223, also entering waveplate filter 1260 having an 0 polarization, will be decomposed into signal 1263 having an O polarization and signal 1265 having an E polarization. Hence, the polarization indicators above and below waveplate filter 1260 in FIG. 12 read O-O and O-E.

Now that the input-output polarizations for the signals propagating through waveplate filters 1230 and 1260 are known, the rotation angles for waveplates 1230a and 1260a (i.e., rotation angles for the first crystal elements of these filters) that would provide for the desired dispersion characteristics may be determined. In one embodiment, this is accomplished using the dispersion properties provided by a dispersion matrix, such as the properties shown in the dispersion matrices of FIGS. 2 and 3. For the same reasons the properties shown in the dispersion matrix of FIG. 2 were used to determine the rotation angle for waveplate 1220a, the properties shown in the dispersion matrix of FIG. 2 are used to determine the rotation angles for waveplates 1230a and 1260a. However, as previously mentioned, the dispersion properties shown in any one of a plurality of dispersion matrices or combination of matrices may be used to determine the rotation angles that provide for the oppositely signed dispersion given the previously determined input and output polarizations.

With respect to waveplate filter 1230, according to the dispersion properties provided by the matrix of FIG. 2, where the polarization for a signal entering an optical component is extraordinary (E), such as the situation for signals 1224 and 1225 entering waveplate 1230, in order for an optical component to introduce a “−” signed dispersion characteristic onto the outgoing signals, the rotation angle set for waveplate filter 1230 should be “a-b-c” (e.g., 35°, −76°, and −64°), rather than “c-b-a”. According to the properties shown in the matrix of FIG. 2, angle set “c-b-a” will not provide the desired “−” signed dispersion, given an E input polarization.

Accordingly, in the example of FIG. 12, waveplate filter 1230 is designed, assembled, arranged, etc., such that the rotation angles for waveplates 1230a, 1230b, and 1230c qualify as crystal rotation angle set “a-b-c” of the matrix of FIG. 2 (particularly, a rotation angle of 35° for waveplate 1230a, a rotation angle of −76° for waveplate 1230b, and a rotation angle of −64° for waveplate 1230c). As a result, under the properties shown in FIG. 2, waveplate filter 1230 introduces a “+” signed dispersion characteristic onto signals 1231 and 1232 and a “−” signed dispersion characteristic onto signals 1233 and 1234.

Because, as discussed above, a “−” signed dispersion characteristic is introduced onto signals 1224 and 1225 by virtue of waveplate filter 1220, in order to achieve the desired dispersion characteristic of a substantial amount of “−” dispersion at P1, a “−” signed dispersion characteristic should be imparted to increase the already imparted “−” dispersion characteristic. In the exemplary device of FIG. 12, signal 1233, which is formed from signal 1224 and thus already has the “−” signed dispersion characteristic of signal 1224 imparted to it, has a second “−” signed dispersion characteristic imparted to it by virtue of waveplate filter 1230. Likewise, signal 1234, which is formed form signal 1225 and thus already has the “−” signed dispersion characteristic of signal 1225 imparted to it, also has a second “−” signed dispersion characteristic imparted to it by virtue of waveplate filter 1230. Therefore, signals 1233 and 1234 are desired.

As a result, the device of FIG. 12 is configured such that these signals are combined by beam displacer 1240 without energy loss. Particularly, signal 1233 (with O polarization) becomes signal 1242 (with E polarization) after it passes through half-waveplate 1236. Signal 1234 (with O polarization) enters beam displacer 1240 where it becomes signal 1244. Signals 1242 and 1244 are then combined in beam displacer 1240 into signal 1246. Signal 1246 is then passed through collimator 1248 to enter second assembly 1130 of FIG. 11 via P1. Since signal 1246 is the result of a combination of signals onto which roughly equal amounts of“−” signed dispersion has been introduced (i.e., “2−” dispersion), signal 1246 exiting the device at outport P1 exhibits a substantial amount of“−” signed dispersion, and thus, the desired dispersion characteristic with respect to P1 is achieved.

Moreover, in the particular configuration of FIG. 12, for reasons similar to those discussed with respect to FIG. 9, signals 1231 and 1232 (with E polarization) diverge after they pass through beam displacer 1240 and/or half-waveplate 1236 respectively. Therefore, their effects are not taken into account.

Meanwhile, with respect to waveplate filter 1260, according to the properties shown in the matrix of FIG. 2, when the polarization for a signal entering an optical component is ordinary (O), such as the situation for signals 1222 and 1223 entering waveplate 1260, in order for an optical component to introduce a “+” signed dispersion characteristic onto at least one of the outgoing signals, the rotation angle set for waveplate filter 1260 should be “a-b-c”, rather than “c-b-a”. According to the properties shown in the matrix, angle set “c-b-a” will not provide the desired “+” signed dispersion, given an O input polarization.

Accordingly, in the example of FIG. 12, waveplate filter 1260 is designed, assembled, arranged, etc., such that the particular rotation angles for waveplates 1260a, 1260b, and 1260c qualify as crystal rotation angle set “a-b-c” of the matrix of FIG. 2 (particularly, a rotation angle of 35° for waveplate 1260a, a rotation angle of −76° for waveplate 1260b, and a rotation angle of −64° for waveplate 1260c). As a result, under the properties shown in FIG. 2, waveplate filter 1260 introduces a “−” signed dispersion characteristic onto signals 1262 and 1263 and a “+” signed dispersion characteristic onto signals 1264 and 1265.

Somewhat similar to the case with respect to waveplate filter 1230, because a “−” signed dispersion characteristic is introduced onto signals 1222 and 1223 by virtue of waveplate filter 1220, in order to achieve the desired dispersion characteristic of zero dispersion at P2, a “+” signed dispersion characteristic should be imparted to compensate for the already imparted “−” signed dispersion characteristic. In the exemplary device of FIG. 12, signal 1264, which is formed from signal 1222 and thus already has the signed dispersion characteristic of signal 1222 imparted to it, has a “+” signed dispersion characteristic imparted to it by virtue of waveplate filter 1260. Likewise, signal 1265, which is formed form signal 1223 and thus already has the “−” signed dispersion characteristic of signal 1223 imparted to it, also has a “+” signed dispersion characteristic imparted to it by virtue of waveplate filter 1260. Therefore, signals 1264 and 1265 are desired.

As a result, the device of FIG. 12 is configured such that signals 1264 and 1265 are combined by beam displacer 1270 without energy loss. Particularly, signal 1265 (with E polarization) becomes signal 1274 (with O polarization) after it passes through half-waveplate 1268. Moreover, to compensate for the index difference between the respective paths of the two desired signals, signal 1264 (with E polarization) passes through glass 1266 where it becomes signal 1272 (with E polarization). Signals 1272 and 1274 are then combined in beam displacer 1270 into signal 1276. Signal 1276 is then passed through collimator 1278 to enter second assembly 1130 of FIG. 11 via P2. Since signal 1276 is the result of a combination of signals onto which roughly equal amounts of “+” and “−” dispersion has been introduced, signal 1276 exiting the device at outport P2 exhibits little or no dispersion, and thus, the desired dispersion characteristic with respect to P2 is achieved as well.

Moreover, in the particular configuration of FIG. 12, for reasons similar to those discussed with respect to FIG. 10, signals 1262 and 1263 (with O polarization) diverge after they pass through half-waveplate 1268 and beam displacer 1270 and glass 1266 and beam displacer 1268 respectively. Therefore, their effects are not taken into account.

Although in the above example, dispersion tailoring optical device 1120 is depicted as having one input and two outputs, the present invention is not limited in this manner. A dispersion tailoring optical device may have fewer or greater numbers of inputs and outputs than optical device 1120. Moreover, a dispersion tailoring optical device need not include three optical components such as the exemplary device of FIG. 12. A dispersion tailoring optical device may include fewer or greater numbers of optical components than that depicted in FIG. 12. For example, a dispersion tailoring optical device may comprise a single optical component as defined with respect to FIG. 6.

As evidenced by the above examples, the method of the present invention may be used to design, configure, arrange, etc., optical components and devices such that the devices and/or components introduce desired dispersion characteristics onto optical signals passing through the components and/or devices. Moreover, if the components and/or devices by themselves are unable to provide the desired dispersion characteristic, the components and/or devices may be combined (such as by cascading) with other components and/or devices to form an assembly which may introduce almost any desired dispersion characteristic onto a signal.

An embodiment of such an assembly is pictured in FIG. 13. In FIG. 13, an interleaver filter 1300 (e.g., similar to the device of FIG. 7) has an input and two outputs P1a and P2a. Suppose it is desired that a signal exiting filter 1300 at output P1a have a dispersion of “4+” (e.g., a dispersion characteristic with a “+” slope and a magnitude four times that of a “+” dispersion characteristic identified in a matrix) and a signal exiting filter 1300 at output P2a exhibit a dispersion sign of “2−” (e.g., a dispersion characteristic with a “−” slope and a magnitude twice that of a “−” dispersion characteristic identified in a matrix) because of significant dispersions that will be introduced onto the signals later on in their respective propagation paths. If interleaver filter 1300 is structurally similar to the exemplary device of FIG. 7, according to the properties shown in the matrix of FIG. 2, the highest magnitude of “+” signed dispersion that can be achieved for output P1a is 2+. Therefore, in order to achieve the desired 4+ dispersion, the filter 900 must be combined with another component or device.

Accordingly, as shown in FIG. 13, the filter 1300 has been arranged in a cascade arrangement with one-input/two-output interleaver filters 1310 and 1320 (also similar to the device of FIG. 7), wherein the signals exiting filter 1300 and P1a become the input signals of filter 1310 and the signals exiting filter 1300 at P2a become the input signals of filter 1320. The dotted line between P1a and filter 1310, as well as the dotted line between P2a and filter 1320, represent the fiber, components, etc., coupling filters 1300, 1310, and 1320 together, to include any components that might be necessary to ensure that the signals entering filters 1310 and 1320 are of the appropriate polarization to achieve the desired dispersion characteristics. Filter 1310 has two outputs P1b and P2b. Likewise, filter 1320 has two outputs P1c and P2c.

In the embodiment of FIG. 13, using the properties shown in the matrix of FIG. 2, in a manner similar to that described earlier, filter 1300 is configured such that the signals exiting filter 1300 at P1a have a “2+” dispersion characteristic introduced onto them by virtue of filter 1300 (ergo, the signals enter filter 1310 with a “2+” dispersion characteristic). Filter 1300 is also configured such that the signals exiting filter 1300 at P1b have zero dispersion introduced onto them by the filter (ergo, the signals enter filter 1320 with a zero dispersion characteristic).

To achieve the desired dispersion characteristics, filter 1310 is configured, preferably according to the table of FIG. 2, such that an additional “2+” dispersion will be introduced onto the signals exiting filter 1310 at output P1b. Thus, as a result of passing through the assembly of FIG. 13, the signals exiting filter 1310 at P1b possess the desired 4+ desired dispersion characteristic. Moreover, filter 1320 is configured such that a “2−” dispersion will be introduced onto the signals exiting filter 1320 at P2c. Therefore, as a result of passing through the assembly of FIG. 13, the signals exiting filter 1320 at P2c possess the other desired dispersion characteristic.

Signals exiting filters 1310 and 1320 at outputs P2b and P1c respectively do not affect the signals exiting at outputs P1b and P2c, and, therefore, their effects are not taken into account here. In one embodiment, the reason for this is that a portion of the input signals to filters 1310 and 1320 lie on the same bandwidth as output signals of P2b and P1c.

The embodiments of the method of the present invention for tailoring the dispersion characteristics introduced by optical devices are not limited to optical devices having at least two optical components (as the term is described with respect to FIG. 6), such as the device of FIG. 7. An example of a single optical component device designed, arranged, configured, etc. according to an embodiment of the method of the present invention to achieve zero dispersion characteristic(s) at P1 and P2 is depicted in FIG. 14.

In the embodiment of FIG. 14, in a manner similar to that discussed earlier, using the properties shown in the dispersion matrix of FIG. 2, it was determined that an extraordinary polarization (indicated by an E in FIG. 14) for signal 1400 entering waveplate filter 1420 along fiber 1425 would achieve zero dispersion at outputs P1 and P2. Moreover, for the same reasons, an angle of 35° was chosen for the rotational angle of the first crystal element of waveplate filter 1420 (i.e., for the rotation angle of waveplate 1420c (the rotation angle being identified in FIG. 14 as A₁)). Similarly, an angle of −76° was chosen for the rotation angle of waveplate 1420b (the rotation angle being identified as A₂ in FIG. 14) and an angle of −64° for the rotation angle of waveplate 1420a (the rotation angle being identified as A₃ in FIG. 14). In previous examples, compared to the value of A₁, the values of A₂ and A₃ did not have a significant effect on the resulting dispersion characteristic(s) of the first component itself, as well as the overall device. However, in the embodiment of FIG. 14, as will be explained below, the value chosen for A3 has a significant effect on the dispersion characteristic(s) introduced by the overall device as well.

Additionally, for reasons that will also be discussed below, the device of FIG. 14 includes both forward and reverse propagation paths. The forward propagation paths are depicted in FIG. 14 by solid lines. On the other hand, the reverse propagation paths are depicted in FIG. 14 by dotted lines. Directional arrows are placed above the signals in FIG. 14 to indicate the direction of propagation.

As a result of the selections and/or determinations discussed above, when the device of FIG. 14 is in operation, for reasons discussed earlier, upon receipt of signal 1400, signal 1400 is transformed into signals 1428 and 1429 by filter 1420 (i.e., first polarization 1428 and second polarization 1429), signal 1429 having an E polarization and signal 1428 having an O polarization. Waveplate filter 1420 is comprised of individual waveplate filters 1420a, 1420b, and 1420c (in at least one embodiment, individual waveplates 1420a, 1420b, and 1420c are made of birefringent crystal). Using the properties shown in the matrix of FIG. 2, it can be seen that waveplate filter 1420 introduces a “+” signed dispersion onto signal 1429 (i.e., the E-E signal) and introduces a “−” signed dispersion onto signal 1428 (i.e., the E-O signal).

After passing through waveplate filter 1420, signals 1428 and 1429 are communicated to birefringent crystal 1424 wherein the signals are separated into different forward propagation paths according to polarization. Signals 1428 and 1429 then pass through quarter-wave plate 1430 and onto reflective material 1431 (e.g., a mirror) whereby the signals are reflected back through quarter-wave plate 1430, the reflected signals being labeled 1432 and 1433. Because as a result of reflective material 1431, signals 1428 and 1429 pass through quarter-wave plate 1430 two times, the combination of reflective material 1431 and quarter-wave plate 1430 effectively acts as a half-wave plate whereby the polarizations of signals 1428 and 1429 are transformed into orthogonal polarizations. Thus, the polarization of signal 1432 is now 0 and the polarization of signal 1433 is now E.

Signals 1432 and 1433 then pass back through birefringent crystal 1424 and waveplate filter 1420 in the reverse propagation paths. As a result, upon receipt of signal 1432 by waveplate filter 1420, from signal 1432, signal 1434 (having the same polarization as signal 1432) and signal 1435 (having an orthogonal polarization to that of 1432) are formed. Likewise, upon receipt of signal 1433 by waveplate filter 1420, from signal 1433, signal 1436 (having a polarization orthogonal to that of signal 1433) and signal 1437 (having the same polarization as signal 1433) are formed. Accordingly, signal 1434 has an input-output polarization of O-O and signal 1435 has one of O-E. Likewise, signal 1436 has an input-output polarization of E-O and signal 1437 has one of E-E.

One effect of the reverse propagation paths is that the rotation angle of the first crystal element of waveplate filter 1420 becomes −64° (i.e., the value of A3 in the forward path). Thus, in one embodiment, using the properties shown in the table of FIG. 2, it is understood that the dispersion introduced onto signal 1434 by filter 1420 has a “−” sign (an O-O polarization and a rotation angle set c-b-a yields a “−” signed dispersion according to the properties shown in the matrix of FIG. 2). The dispersion introduced onto signal 1435 has a “−” sign as well (an O-E polarization and a rotation angle set c-b-a yields a “−” signed dispersion according to the properties shown in the matrix of FIG. 2). Thus, in the embodiment of FIG. 14, the “+” signed dispersion introduced onto signal 1429 by filter 1420 in the forward propagation path is (at least partially) compensated for or canceled out in signals 1434 and 1435 by the “−” dispersions introduced onto them by filter 1420 in the reverse propagation path.

Similarly, the dispersion introduced onto signal 1437 by filter 1420 is “+” signed (an E-E polarization and a rotation angle set c-b-a yields a “+” signed dispersion characteristic according to the properties shown in the matrix of FIG. 2). Likewise, the dispersion introduced onto signal 1436 has a “+” sign as well (an E-O polarization and a rotation angle set c-b-a yields a “+” signed dispersion characteristic according to the properties shown in the matrix of FIG. 2). Thus, in the embodiment of FIG. 14, the “−” signed dispersion introduced onto signal 1428 by filter 1420 in the forward propagation path is (at least partially) compensated for or canceled out in signals 1436 and 1437 by the “+” dispersions introduced onto them by filter 1420 in the reverse propagation path. Thus, each of signals 1434, 1435, 1436, and 1437 exhibit little or no dispersion as a result of waveplate filter 1420.

After signals 1432 and 1433 are transformed into signals 1434, 1435, 1436, and 1437 respectively, signals 1434, 1435, 1436, and 1437 are communicated to polarization beam splitters 1445, 1465, and 1455 where they are separated according to polarization. Thus, after exiting waveplate filter 1420 in the reverse propagation path, signals 1434 and 1435 are separated by polarization beam splitter 1445. In particular, signal 1434, having an O polarization, is directed toward beam splitter 1455 by beam splitter 1445. Signal 1434 is then directed out of the device at P2 by beam splitter 1455, also a result of its O polarization. Signal 1435, on the other hand, having an E polarization, propagates through beam splitter 1445 and is discarded.

Meanwhile, signals 1436 and 1437 are separated by polarization beam splitter 1445 as well. Signal 1436, having an O polarization, is directed toward beam splitter 1465 by beam splitter 1445. Signal 1436 is then directed out of the device at P1 by beam splitter 1465, also a result of its O polarization. Signal 1437, on the other hand, having an E polarization, propagates through beam splitter 1445 and is discarded.

Because, as mentioned earlier, preferably, equal amounts of “−” and “+” dispersion are introduced onto signals 1434 and 1436 during the forward and reverse propagation paths, signals 1434 and 1436 exit the device of FIG. 13 at P2 and P1 exhibiting little or no dispersion as a result of the device.

It will be appreciated that the particular dimensions, as well as the elements, of the optical components depicted herein are by way of example only for the components may have different dimensions, as well as more or fewer elements, inputs, outputs, etc. The same holds true for the devices, systems, assemblies, etc. Furthermore, in the examples provided above, the magnitude of the dispersion characteristic(s) introduced by each optical component, including the dispersion characteristics introduced in the forward and reverse propagation paths through a component, are approximately equal. However, this is not a requirement of the present invention. In fact, an inequality of magnitude is utilized in embodiments of the present invention to provide a wider range of possible dispersion characteristics. For example, in at least one embodiment, rather than completely compensating for a “+” signed dispersion characteristic of a particular magnitude introduced onto a signal by a first optical component, a second optical component instead halves the magnitude of the “+” signed dispersion characteristic to achieve a desired dispersion characteristic by imparting a “−” signed dispersion characteristic of half of the magnitude of the “+” signed characteristic to the signal.

The methods and structures described herein alleviate the problems associated with the prior art by enabling any desired dispersion characteristic to be achieved. Thus, the present invention provides flexibility in customizing, tailoring, and/or managing the dispersion introduced onto signals by optical components. Likewise, not only may the dispersion characteristics introduced by optical components be tailored or managed, but the dispersion characteristics for an overall optical device or an entire optical network may be tailored and/or managed as well.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiment of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or alter to be developed that perform substantially the same function or achieve substantially the same result as the corresponding embodiments described herein may be utilized according to steps.

What is claimed is:

1. A method for tailoring a dispersion characteristic of an optical signal, comprising:
receiving an optical signal at a crystal element of an optical component, the crystal element arranged at a rotation angle based at least in part upon a polarization of the optical signal entering the crystal element and a selected property of at least one dispersion characteristic to impart upon the optical signal exiting the optical component; communicating the optical signal exiting the optical component.

2. The method of claim 1, wherein:
the optical signal exiting the optical component comprises a first polarization and a second polarization; and
the selected property comprises a positively sloped dispersion characteristic for the first polarization of the optical signal exiting the optical component and for the second polarization of the optical signal exiting the optical component.

3. The method of claim 1, wherein:
the optical signal exiting the optical component comprises a first polarization and a second polarization; and
the selected property comprises a negatively sloped dispersion characteristic for the first polarization of the optical signal exiting the optical component and for the second polarization of the optical signal exiting the optical component.

4. The method of claim 1, wherein:
the optical signal exiting the optical component comprises a first polarization and a second polarization; and
the selected property comprises a positively sloped dispersion characteristic for the first polarization of the optical signal exiting the optical component and a negatively sloped dispersion characteristic for the second polarization of the optical signal exiting the optical component.

5. The method of claim 1, wherein:
the optical signal exiting the optical component comprises a first polarization and a second polarization; and
the rotation angle is further determined based upon at least one of the first polarization of the optical signal exiting the optical component and the second polarization of the optical signal exiting the optical component.

6. The method of claim 1, wherein the crystal element comprises a birefringent crystal.

7. The method of claim 1, wherein:
the optical component comprises a waveplate filter having a plurality of waveplates; and
the crystal element comprises one of the plurality of waveplates.

8. The method of claim 7, wherein the waveplates are arranged such that the crystal element is the first element to receive the optical signal among the waveplates.

9. The method of claim 1, wherein:
the crystal element comprises a first crystal element;
the optical component comprises a first optical component; and
the optical signal exiting the first optical component comprises an intermediate optical signal;
the method further comprising receiving the intermediate optical signal at a crystal element of a second optical component, the crystal element of the second optical component arranged at a rotation angle based upon a polarization of the intermediate optical signal entering the crystal element of the second optical component and a selected property of at least one dispersion characteristic to impart upon the intermediate optical signal exiting the second optical component.

10. The method of claim 9, wherein the property of the dispersion characteristic imparted upon the intermediate optical signal exiting the second optical component is selected to compensate for the dispersion characteristic imparted by the first optical component.

11. The method of claim 9, wherein the property of the dispersion characteristic imparted upon the optical signal exiting the first optical component is selected to compensate for the dispersion characteristic imparted by the second optical component.

12. The method of claim 1, wherein said receiving and communicating comprise propagating the optical signal in a forward propagation path, the method further comprising propagating the optical signal through the optical component in a reverse propagation path.

13. The method of claim 12, wherein propagating the optical signal in the reverse propagation path imparts a dispersion characteristic that compensates for the dispersion characteristic imparted upon the optical signal in the forward propagation path.

14. An optical component for tailoring a dispersion characteristic of an optical signal, comprising a crystal element arranged at a rotation angle based at least in part upon a polarization of the optical signal entering the crystal element and a selected property of at least one dispersion characteristic to impart upon the optical signal exiting the optical component.

15. The optical component of claim 14, wherein:
the optical signal exiting the optical component comprises a first polarization and a second polarization; and
the selected property comprises a positively sloped dispersion characteristic for the first polarization of the optical signal exiting the optical component and for the second polarization of the optical signal exiting the optical component.

16. The optical component of claim 14, wherein:
the optical signal exiting the optical component comprises a first polarization and a second polarization; and
the selected property comprises a negatively sloped dispersion characteristic for the first polarization of the optical signal exiting the optical component and for the second polarization of the optical signal exiting the optical component.

17. The optical component of claim 14, wherein:
the optical signal exiting the optical component comprises a first polarization and a second polarization; and
the selected property comprises a positively sloped dispersion characteristic for the first polarization of the optical signal exiting the optical component and a negatively sloped dispersion characteristic for the second polarization of the optical signal exiting the optical component.

18. The optical component of claim 14, wherein:
the optical signal exiting the optical component comprises a first polarization and a second polarization; and
the rotation angle is further determined based upon at least one of the first polarization of the optical signal exiting the optical component and the second polarization of the optical signal exiting the optical component.

19. The optical component of claim 14, wherein the crystal element comprises a birefringent crystal.

20. The optical component of claim 14, wherein the optical component further comprises a waveplate filter having a plurality of waveplates and the crystal element comprises one of the plurality of waveplates.

21. The optical component of claim 20, wherein the waveplates are arranged such that the crystal element is the first element among the waveplates to receive the optical signal in a forward propagation path, the optical component further comprising a reflective material operable to reflect the optical signal such that it propagates through the waveplate filter in a reverse propagation path.

22. The optical component of claim 21, wherein propagating the optical signal in the reverse propagation path imparts a dispersion characteristic that compensates for the dispersion characteristic imparted upon the optical signal in the forward propagation path.

23. The optical component of claim 21, further comprising a quarter waveplate positioned between the waveplate filter and the reflective material.

24. A system for tailoring a dispersion characteristic of an optical signal, comprising:
dispersion tailoring device operable to process an input optical signal into at least one output optical signal, the dispersion tailoring device comprising at least one filter having at least one crystal element arranged at a rotation angle based at least in part upon a polarization of an intermediate optical signal entering the crystal element and a selected property of at least one dispersion characteristic associated with the intermediate optical signal exiting the filter, wherein the output optical signal is generated using the intermediate optical signal exiting the filter; and
at least one dispersion introducing component that imparts a dispersion characteristic to one of the input optical signal and the output optical signal;
wherein the property of the dispersion characteristic associated with the intermediate optical signal exiting the filter is selected to compensate for the dispersion characteristic imparted by the at least one dispersion introducing component.

25. The system of claim 24, wherein:
the intermediate optical signal exiting the filter comprises a first polarization and a second polarization; and
the selected property comprises a positively sloped dispersion characteristic for the first polarization of the intermediate optical signal exiting the filter and for the second polarization of the intermediate optical signal exiting the filter.

26. The system of claim 24, wherein:
the intermediate optical signal exiting the filter comprises a first polarization and a second polarization; and
the selected property comprises a negatively sloped dispersion characteristic for the first polarization of the intermediate optical signal exiting the filter and for the second polarization of the intermediate optical signal exiting the filter.

27. The system of claim 24, wherein:
the intermediate optical signal exiting the filter comprises a first polarization and a second polarization; and
the selected property comprises a positively sloped dispersion characteristic for the first polarization of the intermediate optical signal exiting the filter and a negatively sloped dispersion characteristic for the second polarization of the intermediate optical signal exiting the filter.

28. The system of claim 24, wherein:
the intermediate optical signal exiting the filter comprises a first polarization and a second polarization; and
the rotation angle is further determined based upon at least one of the first polarization of the intermediate optical signal exiting the filter and the second polarization of the intermediate optical signal exiting the filter.

29. The system of claim 24, wherein:
the filter comprises a first filter;
the crystal element comprises a first crystal element;
the dispersion tailoring device further comprises a second filter having a crystal element;
the intermediate optical signal exiting the first filter enters the crystal element of the second filter;
the crystal element of the second filter is arranged at a rotation angle determined based upon a polarization of the intermediate optical signal entering the crystal element of the second filter and a selected property of at least one dispersion characteristic associated with the intermediate optical signal exiting the second filter; and
the output optical signal is generated using the intermediate optical signal exiting the second filter.
